(19) United States
(12) Patent Application Publication
(10) Pub. No.: US 2015/0378211 A1
(43) Pub. Date: Dec. 31, 2015

(54) OPTICAL FILM, POLARIZING PLATE AND LIQUID CRYSTAL DISPLAY DEVICE

(71) Applicant: FUJIFILM Corporation, Tokyo (JP)

(72) Inventors: Ryuji SANETO, Kanagawa (JP); Shusuke ARITA, Kanagawa (JP); Hiromichi FURUKAWA, Kanagawa (JP)

(73) Assignee: FUJIFILM CORPORATION, Tokyo (JP)

(21) Appl. No.: 14/847,779

(22) Filed: Sep. 8, 2015

Related U.S. Application Data
(63) Continuation of application No. 14/201,273, filed on Mar. 7, 2014.

(30) Foreign Application Priority Data
Mar. 8, 2013 (JP) 2013-046652
Apr. 12, 2013 (JP) 2013-084365
Apr. 24, 2013 (JP) 2013-091450

(51) Int. Cl. G02F 1/1335; G02F 1/13363

(52) U.S. Cl. CPC G02F 1/133528; G02F 1/13363

(57) ABSTRACT

A VA mode liquid crystal display device including a backlight; a first polarizing plate; a VA mode liquid crystal cell; and a second polarizing plate, in this order, wherein the first polarizing plate includes a first polarizer and a first optical film, and the second polarizing plate includes a second polarizer and a second optical film, the optical film contains an acrylic resin, and a tensile elastic modulus of the optical film in a machine direction, which are abbreviated as EMD, and a tensile elastic modulus in a direction perpendicular to the machine direction, which is abbreviated as ETD, satisfy the relationship of Equation (1):

EMD/ETD<0.8. Equation (1)

### CROSS-REFERENCE TO RELATED APPLICATION(S)

The present application is a continuation application of parent U.S. application Ser. No. 14/201,273, filed on Mar. 7, 2014, which claims priority from Japanese Patent Application Nos. 2013-046652 filed on Mar. 8, 2013, 2013-084365 filed on Apr. 12, 2013, and 2013-091450 filed on Apr. 24, 2013, the entire contens of all of which are incorporated herein by reference.

### BACKGROUND

1. Field

The present disclosure relates to an optical film, a polarizing plate and a liquid crystal display device.

2. Description of Related Art

The liquid crystal device is a space-saving image display device with low electric power consumption, and the use thereof is increasing every year. A wide viewing angle liquid crystal mode such as a VA mode and an IPS mode is being put into practice, and accordingly, the demand for a liquid crystal display device is rapidly spreading even in the market where a high-quality image such as a television is required.

As the use of the liquid crystal display device is expanding, the liquid crystal display device has been required to have both a large size and a high-quality texture. The liquid crystal display device includes a liquid crystal cell and polarizing plates provided on a viewing side (front side) and a backlight side (rear side) of the liquid crystal cell, and both of the polarizing plates are bonded to both surfaces of the liquid crystal cell substrate by means of an adhesive bond and the like.

The polarizing plate used in the liquid crystal display device generally configured to include a polarizer which is composed of a polyvinyl alcohol film and the like, on which iodine or a dye is adsorbed and aligned, and transparent optical films as protective films are adhered to inner and outer sides thereof.

Japanese Patent Application Laid-Open No. 2009-292869 discloses a polarizing plate, in which as protective films of a polarizer, an acrylic film on one side of the polarizer and a cellulose acylate film on the other side are used.

Japanese Patent Application Laid-Open Nos. 2009-265365 and 2012-008417 also disclose a mixed film of an acrylic resin and a cellulose ester-based resin

A general polarizing plate is composed of a polyvinyl alcohol-based polarizer and an optical film. The polyvinyl alcohol-based polarizer is uniaxially-stretched after being dyed with iodine, and the stretched direction becomes an absorption axis. As a result of intensive studies, the present inventors have found that the polarizer tends to absorb moisture and be expanded in a direction orthogonal to the stretched direction of the polarizer.

The present inventors have investigated a mixed film of an acrylic resin and a cellulose ester-based resin, but have found that due to high moisture permeability, moisture absorption and expansion of the polarizer is generated by water which permeates the film, and further, due to high moisture absorption and expansion of the film itself, further improvements are needed. Further, it became obvious that a display unevenness is easily generated due to photoelasticity of an optical film.

A problem with moisture absorption and expansion of a polarizing plate occurs in a process of bonding a polarizing plate to a liquid crystal cell. Since a polarizing plate is subjected to a high temperature drying process (drying temperature of 60° C. to 80° C.), and then is sealed in a moisture barrier bag, the polarizing plate is stored in a dry state. The process of adhering a polarizing plate to a liquid crystal cell is performed under a high humid environment (temperature of 15° C. to 30° C., relative humidity of 55% to 65%) in order to suppress generation of static electricity. Accordingly, a polarizing plate removed from a moisture bather bag during the bonding process absorbs moisture and is expanded, and is bonded to a liquid crystal cell in a state in which the polarizing plate absorbs moisture and is expanded.

Due to moisture absorption and expansion of the polarizing plate in a direction orthogonal to the stretched direction of the polarizer, the polarizing plate is elongated according to the difference in humidity between the process of adhering the polarizing plate to the liquid crystal cell and the use environment of the liquid crystal display device, and the relative positions of the liquid crystal cell and the polarizing plate are changed. The liquid crystal display device has a part corresponding to a frame called a bezel at an image peripheral part. The bezel serves to aesthetically finish the display device by hiding the end of the polarizing plate. In order to allow the liquid crystal display device to have a large size and a high-quality texture, narrowing the width of the bezel proceeds, and accordingly, narrowing the gap between a glass end and a polarizing plate end proceeds. For that reason, the polarizing plate absorbs moisture and is expanded, and as a result, a problem in that a polarizing plate end protrudes from a glass end has easily occurred.

### SUMMARY

An object of the present disclosure is to provide a polarizing plate having low humidity expansion, which is suitable for the manufacture of a high-quality liquid crystal display device, and an optical film used in the polarizing plate.

(1) An optical film including: an acrylic resin, wherein a tensile elastic modulus in a machine direction, which are abbreviated as EMD, and a tensile elastic modulus in a direction perpendicular to the machine direction, which is abbreviated as ETD, satisfy the relationship of Equation (1):

EMD/ETD<0.8. Equation (1)
(2) The optical film according to (1), wherein the EMD is 1.2×10⁹ to 4.0×10⁹ N/m² and the ETD is 1.5×10⁹ to 5.0×10⁹ N/m².

(3) The optical film according to (1), wherein an in-plane retardation value Re (nm) represented by Equation (i) and a retardation value in a thickness-direction Rth (nm) represented by Equation (ii), of the optical film, satisfy Equation (iii) and Equation (iv):

Re=(nx−ny)×d; (i)

Rth=((nx+ny)/2−nz)×d; (ii)

0≦Re≦20; and (iii)

|Rth|≦25, (iv)

wherein nx is a refractive index in an in-plane slow axis direction of the optical film, ny is a refractive index in an in-plane fast axis direction of the optical film, nz is a refractive index in a thickness direction of the optical film, and d is a thickness, of which unit is nm, of the optical film.

(4) The optical film according to (1), wherein the optical film is an acrylic resin film.

(5) The optical film according to (1), wherein at least one layer of a pattern phase difference layer, a λ/4 layer, a hardcoat layer, an antiglare layer, an antireflection layer, an antistatic layer, an optically anisotropic layer and an easily adhesive layer is provided on a surface of the optical film.

(6) A polarizing plate including: a polarizer; and the optical film according to (1) on at least one surface of the polarizer.

(7) The polarizing plate according to (6), wherein the optical film is an acrylic film.

(8) The polarizing plate according to (6), wherein the optical films according to (1) is provided on both surfaces of the polarizer.

(9) The polarizing plate according to (8), wherein the optical film is an acrylic resin.

(10) A liquid crystal display device including at least one polarizing plate of (6).

(11) A stereoscopic display device including at least one polarizing plate of (6).

According to one aspect of the present disclosure, it is possible is to provide a polarizing plate having low humidity expansion, which is suitable for the manufacture of a high-quality liquid crystal display device, and an optical film used in the polarizing plate.

### DETAILED DESCRIPTION OF EXEMPLARY EMBODIMENTS

An optical film of the present disclosure is composed of an acrylic resin.

The acrylic resin is a concept including a methacrylic resin, and also includes derivatives of acrylate/methacrylate, and particularly (co)polymers of acrylate ester/methacrylate ester.

The acrylic resin also includes an acryl-based resin having a ring structure in a main chain thereof in addition to methacrylic resins, and includes a polymer having a lactone ring, a maleic anhydride-based polymer having a succinic anhydride ring, a polymer having a glutaric anhydride ring, and a glutarimide ring-containing polymer.

In addition, “composed of an acrylic resin” indicates that an acryl-based resin is included in an amount of 70% by mass or more in an optical film, and an acryl-based resin is included in an amount of preferably 80% by mass or more, and more preferably 90% by mass or more in an optical film.

(Acrylic Resin)

The repeating structural unit of the acrylic resin is not particularly limited. It is preferred that the acrylic resin has a repeating structural unit derived from an acrylic acid ester monomer as a repeating structural unit.

The acrylic acid ester is not particularly limited, but examples thereof include acrylic acid ester such as methyl acrylate, ethyl acrylate, n-butyl acrylate, isobutyl acrylate, t-butyl acrylate, cyclohexyl acrylate, and benzyl acrylate; methacrylic acid ester such as methyl methacrylate, ethyl methacrylate, propyl methacrylate, n-butyl methacrylate, isobutyl methacrylate, t-butyl methacrylate, cyclohexyl methacrylate, and benzyl methacrylate; and the like, and these may be used either alone or in combination of two or more thereof. Among them, methyl methacrylate is particularly preferred from the viewpoint of excellent heat resistance and transparency.

When the acrylic acid ester is used as a main component, the content thereof in the monomer component used in the polymerization process is preferably 50 to 100% by mass, more preferably 70 to 100% by mass, still more preferably 80 to 100% by mass, and particularly preferably 90 to 100% by mass, in order to sufficiently exhibit the effect of the present invention.

It is preferred that the glass transition temperature (Tg) of a resin having the acrylic acid ester as a main component is in a range of 80° C. to 120° C.

The weight average molecular weight of the resin having the acrylic acid ester as a main component is preferably in a range of 50,000 to 500,000.

—Acrylic Resin Having Ring Structure in Main Chain—

Among the acrylic resins, preferred is an acrylic resin having a ring structure in a main chain thereof. Heat resistance may be improved by introducing a ring structure into the main chain to increase stiffness of the main chain.

In the present invention, among the acrylic resins having a ring structure in a main chain thereof, preferred is any one of a polymer containing a lactone ring structure in a main chain thereof, a maleic anhydride-based polymer having a succinic anhydride ring in a main chain thereof, a polymer having a glutaric anhydride ring structure in a main chain thereof, and a polymer having a glutarimide ring structure in a main chain thereof. Among them, a polymer containing a lactone ring structure in a main chain thereof and a polymer having a glutarimide ring structure in a main chain thereof are more preferred.

Hereafter, these polymers having a ring structure in a main chain thereof will be sequentially described.

(1) Acrylic Resin Having Lactone Ring Structure in Main Chain Thereof

The acrylic resin having a lactone ring structure in a main chain thereof (hereinafter, also referred to as a lactone ring-containing polymer) is not particularly limited as long as the acrylic resin is an acrylic resin having a lactone ring in a main chain thereof, but preferably has a lactone ring structure represented by the following Formula (100).

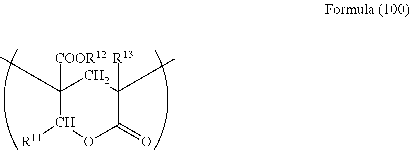

In Formula (100), R¹¹, R¹² and R¹³ each independently represent a hydrogen atom or an organic residue having 1 to 20 carbon atoms, and the organic residue may contain a hydrogen atom.

Here, as the organic residue having 1 to 20 carbon atoms, an alkyl group having 1 to 6 carbon atoms is preferred, and specifically, a methyl group, an ethyl group, an isopropyl group, an n-butyl group, a t-butyl group, and the like are preferred.

The content ratio of the lactone ring structure represented by Formula (100) in the lactone ring-containing polymer structure is preferably 5 to 90% by mass, more preferably 10 to 70% by mass, still more preferably 10 to 60% by mass, and particularly preferably 10 to 50% by mass. By setting the content ratio of the lactone ring structure to 5% by mass or more, the obtained polymer tends to have improved heat resistance and surface hardness, and by setting the content ratio of the lactone ring structure to 90% by mass or less, the obtained polymer tends to have improved molding processability.

Meanwhile, the content ratio of the lactone ring structure may be calculated by the following Formula.

Content ratio (% by mass) of the lactone ring=B×A×M_{R}/Mₘ

(In the formula, B is a mass-containing ratio in the composition of the monomer used in the copolymerization of a raw material monomer having a structure (a hydroxyl group) involved in the lactone cyclization, M_{R} is a formula weight of a lactone ring structural unit to be produced, Mₘ is a molecular weight of a raw material monomer having a structure (a hydroxyl group) involved in the lactone cyclization, and A is a lactone cyclization ratio)

The lactone cyclization ratio may be calculated from a weight reduction and addition heat and weight reduction ratio by a dealcoholization reaction from 150° C. before a theoretical weight loss amount and a weight loss are initiated to 300° C. before decomposition of the polymer is initiated, for example, when the cyclization reaction is accompanied by the alcoholization reaction.

A method of preparing the acrylic resin having a lactone ring structure is not particularly limited. Preferably, the acrylic resin having a lactone ring structure is obtained by polymerizing the following predetermined monomer to obtain a polymer (p) having a hydroxyl group and an ester group in the molecular chain thereof, and then subjecting the obtained polymer (p) to heat treatment in a temperature range of 75° C. to 120° C. to perform the lactone cyclization condensation of introducing a lactone ring structure into the polymer.

In the polymerization process, a polymer having a hydroxyl group and an ester group in a molecular chain thereof is obtained by performing a polymerization reaction of a monomer component including a monomer represented by the following Formula (101).

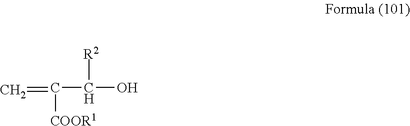

(In the formula, R¹ and R² each independently represent a hydrogen atom or an organic residue having 1 to 20 carbon atoms.)

Examples of the monomer represented by Formula (101) include 2-(hydroxymethyl)methyl acrylate, 2-(hydroxymethyl)ethyl acrylate, 2-(hydroxymethyl)isopropyl acrylate, 2-(hydroxymethyl)n-butyl acrylate, 2-(hydroxymethyl)t-butyl acrylate, and the like. Among them, 2-(hydroxymethyl)methyl acrylate and 2-(hydroxymethyl)ethyl acrylate are preferred, and in terms of a high effect of improving heat-resistance, 2-(hydroxymethyl)methyl acrylate is particularly preferred. The monomer represented by Formula (101) may be used either alone or in combination of two or more thereof.

The content ratio of the monomer represented by Formula (101) in the monomer component used in the polymerization process has a lower limit in a preferred range from the viewpoint of heat resistance, solvent resistance and surface hardness, and an upper limit in a preferred range from the viewpoint of molding processability of the obtained polymer, and is preferably 5 to 90% by mass, more preferably 10 to 70% by mass, still more preferably 10 to 60% by mass, and particularly preferably 10 to 50% by mass, based on these viewpoints.

The monomer component used in the polymerization process may include a monomer other than the monomer represented by Formula (101). The monomer is not particularly limited, but preferred examples thereof include acrylic acid ester, a hydroxyl group-containing monomer, an unsaturated carboxylic acid, and a monomer represented by the following Formula (102). The monomer other than the monomer represented by Formula (101) may be used either alone or in combination of two or more thereof.

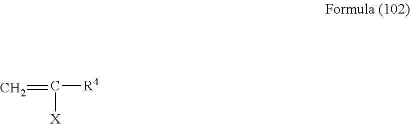

(In the formula, R⁴ represents a hydrogen atom or a methyl group, X represents a hydrogen atom, an alkyl group having 1 to 20 carbon atoms, an aryl group, an —OAc group, a —CN group, a —CO—R⁵ group or a —CO—R⁶ group, Ac represents an acetyl group, and R⁵ and R⁶ represent a hydrogen atom or an organic residue having 1 to 20 carbon atoms.)

The weight average molecular weight of the lactone-containing polymer is preferably 10,000 to 2,000,000, more preferably 20,000 to 1,000,000, and particularly preferably 50,000 to 500,000.

The mass reduction ratio of the lactone-ring containing polymer is preferably 1% or less, more preferably 0.5% or less, and still more preferably 0.3% or less in a range of 150° C. to 300° C. in the dynamic TG measurement thereof. With respect to the dynamic TG measurement method, it is possible to use a method described in Japanese Patent Application Laid-Open No. 2002-138106.

Since the lactone ring-containing polymer has a high cyclization condensation reaction ratio, the dealcoholization reaction rarely occurs during the manufacturing process of molded articles, and thus it is possible to avoid a drawback in that bubbles or silver streaks enter the molded articles after molding resulting from the alcohol. In addition, since the lactone ring structure is sufficiently introduced into the polymer due to high cyclization condensation reaction ratio, the obtained lactone ring-containing polymer has high heat resistance.

When the lactone ring-containing polymer is prepared with a chloroform solution at a concentration of 15% by mass, the coloring degree (YI) thereof is preferably 6 or less, more preferably 3 or less, still more preferably 2 or less, and particularly preferably 1 or less. When the coloring degree (YI) is 6 or less, the lactone ring-containing polymer may be preferably used in the present invention because it is difficult for problems such as damage to transparency due to colorization to occur.

For the lactone ring-containing polymer, a 5% mass decreasing temperature in the thermogravimetric analysis (TG) is preferably 330° C. or more, more preferably 350° C. or more, and still more preferably 360° C. or more. The 5% mass decreasing temperature in the thermogravimetric analysis (TG) is an index of thermal stability, and when this value is set to 330° C. or more, sufficient thermal stability tends to be easily exhibited. For the thermogravimetric analysis, the dynamic TG measurement device may be used.

The glass transition temperature (Tg) of the lactone ring-containing polymer is preferably 115° C. to 180° C., more preferably 120° C. to 170° C., and still more preferably 125° C. to 160° C.

(2) Maleic Anhydride-Based Polymer Having Succinic Anhydride Ring in Main Chain Thereof

A succinic anhydride structure in a main chain is formed in a molecular chain (in a main structure of the polymer) of the polymer, and thus high heat resistance is imparted to an acrylic resin which is a copolymer, and the glass transition temperature (Tg) is also increased, which is preferred.

The glass transition temperature (Tg) of the maleic anhydride-based polymer having a succinic anhydride ring in a main chain thereof is preferably 110° C. to 160° C., more preferably 115° C. to 160° C., and still more preferably 120° C. to 160° C.

The weight average molecular weight of the maleic anhydride-based polymer having a succinic anhydride ring in a main chain thereof is preferably in a range of 50,000 to 500,000.

The maleic anhydride unit used in the copolymerization with the acrylic resin is not particularly limited, but examples thereof include a maleic acid-modified resin described in Japanese Patent Application Laid-Open Nos. 2008-216586, 2009-052021 and 2009-196151, and Japanese Unexamined Patent Application Publication No. 2012-504783.

Meanwhile, it is not intended to limit the present invention thereto.

As a commercially available product of the maleic acid-modified resin, DELPET 980N manufactured by Asahi Kasei Chemicals Corporation as a maleic acid-modified MAS resin (a methyl methacrylate-acrylonitrile styrene copolymer) may be preferably used.

As a method of preparing an acrylic resin including a maleic anhydride unit, a publicly known method may be used without a particular limitation.

The maleic acid-modified resin is not limited as long as the resin includes a maleic anhydride unit in the polymer obtained, and examples thereof include an (anhydrous)maleic acid-modified MS resin, (anhydrous)maleic acid-modified MAS resin (a methyl methacrylate-acrylonitrilestyrene copolymer), an (anhydrous)maleic acid-modified MBS resin, an (anhydrous)maleic acid-modified AS resin, an (anhydrous)maleic acid-modified AA resin, an (anhydrous)maleic acid-modified ABS resin, an ethylene-maleic anhydride copolymer, an ethylene-acrylic acid-maleic anhydride copolymer, a maleic anhydride grafted polypropylene and the like.

The maleic anhydride unit is a structure represented by the following Formula (200).

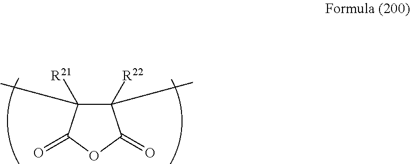

In Formula (200), R²¹ and R²² each independently represent a hydrogen atom or an organic residue having 1 to 20 carbon atoms.

The organic residue is not particularly limited as long as the organic residue has carbon atoms in a range of 1 to 20, but examples thereof include a straight or branched alkyl group, a straight or branched alkylene group, an aryl group, an —OAc group, a —CN group and the like. In addition, the organic residue may include an oxygen atom. Ac represents an acetyl group.

R²¹ and R²² have preferably 1 to 10 carbon atoms, and more preferably 1 to 5 carbon atoms.

When R²¹ and R²² each represent a hydrogen atom, it is also preferred that the organic residue further include other copolymerization components from the viewpoint of adjusting the intrinsic birefringence. As a 3- or more-membered heat resistant acrylic resin, for example, a methyl methacrylate-maleic anhydride-styrene copolymer may be preferably used.

(3) Polymer Having Glutaric Anhydride Ring Structure in Main Chain Thereof

A polymer having a glutaric anhydride ring structure in a main chain thereof refers to a polymer having a glutaric anhydride unit.

It is preferred that the polymer having a glutaric anhydride unit has a glutaric anhydride unit (hereinafter, referred to as a glutaric anhydride unit) represented by the following Formula (300).

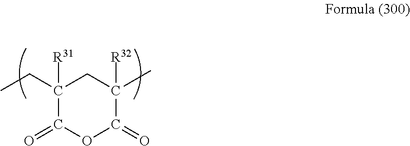

In Formula (300), R³¹ and R³² each independently represent a hydrogen atom or an organic residue having 1 to 20 carbon atoms. Meanwhile, the organic residue may include an oxygen atom. R³¹ and R³² particularly preferably represent a hydrogen atom or an alkyl group having 1 to 5 carbon atoms, which may be the same or different.

It is preferred that the polymer having a glutaric anhydride unit is an acrylic resin containing a glutaric anhydride unit. It is preferred that the acrylic resin has a glass transition temperature (Tg) of 120° C. or more from the viewpoint of heat resistance.

The glass transition temperature (Tg) of the polymer having an anhydrous a glutaric acid ring structure in a main chain thereof is preferably 110° C. to 160° C., more preferably 115° C. to 160° C., and still more preferably 120° C. to 160° C.

The weight average molecular weight of the polymer having a glutaric anhydride ring structure in a main chain thereof is preferably in a range of 50,000 to 500,000.

The content of the glutaric anhydride unit based on the acrylic resin is preferably 5 to 50% by mass, and more preferably 10 to 45% by mass. By setting the content to 5% by mass or more, and more preferably 10% by mass or more, it is possible to obtain an effect of enhancing heat resistance, and furthermore, it is also possible to obtain an effect of enhancing weather resistance.

(4) Acrylic Resin Having Glutarimide Ring Structure in Main Chain Thereof

The acrylic resin having a glutarimide ring structure in a main chain thereof (hereinafter, also referred to as a glutarimide-based resin) may have a grlutarimide ring structure in a main chain thereof, thereby exhibiting a preferred characteristic balance in terms of optical characteristics, heat resistance, or the like. It is preferred that the acrylic resin having a glutarimide ring structure in a main chain thereof at least contains

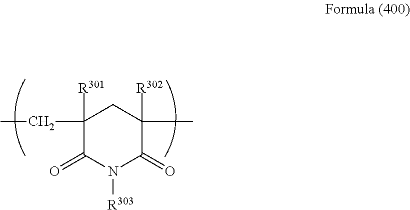

a glutarimide resin having 20% by mass or more of a glutarimide unit (however, in the formula, R³⁰¹, R³⁰² and R³⁰³ are independently hydrogen, or an alkyl group, an cycloalkyl group and an aryl group having 1 to 12 carbon atoms, which are unsubstituted or substituted) represented by the following Formula (400).

In a preferred glutarimide unit constituting the glutarimide-based resin used in the present invention, R³⁰¹ and R³⁰² are hydrogen or a methyl group, and R³⁰³ is a methyl group or a cyclohexyl group. The glutarimide unit may be a single type, and may allow R³⁰¹, R³⁰² and R³⁰³ to include a plurality of other types.

A preferred second constitutional unit constituting the glutarimide-based resin used in the present invention is a unit composed of acrylic acid ester or methacrylic acid ester. Examples of the preferred acrylic acid ester or methacrylic acid ester constitutional unit include methyl acrylate, ethyl acrylate, methyl methacrylate, and the like. Furthermore, other examples of preferred imidizable units include N-alkyl methacrylamide such as N-methyl methacrylamide or N-ethyl methacrylamide. These second constitutional units may be a single type, or may include a plurality of types.

The content of the glutarimide unit represented by Formula (400) in the glutarimide-based resin is preferably 20% by mass to 95% by mass based on the total repeating unit of the glutarimide-based resin. The content is more preferably 50 to 90% by mass, and still more preferably 60 to 80% by mass. When the content of the glutarimide unit is set to 20% by mass or more, the content is preferred in terms of securing heat resistance and transparency of the film obtained. When the content is set to 95% by mass or less, the content is preferred from the viewpoint of brittleness, transparency and forming a film.

The glutarimide-based resin may be a resin in which a third constitutional unit is further copolymerized, if necessary. As an example of the preferred third constitutional unit, it is possible to use a constitutional unit obtained by copolymerizing a styrene-based monomer such as styrene, substituted styrene or α-methylstyrene, an acrylic monomer such as butyl acrylate, a nitrile-based monomer such as acrylonitrile or methacrylonitrile, and a maleimide-based monomer such as maleimide, N-methylmaleimide, N-phenylmaleimide, and N-cyclohexylmaleimide. These constitutional units may be directly copolymerized with a glutarimide unit and an imidizable unit in the glutarimide-based resin, and may also be graft-copolymerized with a rein having the glutarimide unit and the imidizable unit. When the third component is added thereto, the content ratio of the third component in the glutarimide-based resin is preferably 5% by mol to 30% by mol based on the total repeating unit in the glutarimide-based resin.

The glutarimide-based resin is described in U.S. Pat. Nos. 3,284,425 and 4,246,374 and Japanese Patent Application Laid-Open No. H2-153904, and the like, and may be obtained by using, as a resin having an imidizable unit, a resin obtained by using methacrylic acid methyl ester and the like as a main raw material, and imidizing the resin having an imidizable unit using ammonia or substituted amine. When the glutarimide-based resin is obtained, there is a case where a unit composed of acrylic acid or methacrylic acid or anhydride thereof as a reaction byproduct is introduced into the glutarimide-based resin. The presence of the constitutional unit, particularly, acid anhydride reduces total light transmittance or haze of the film of the present invention to be obtained, and thus is not preferred. The content of acrylic acid or methacrylic acid is 0.5 millequivalents or less per 1 g, preferably 0.3 millequivalents or less per 1 g, and more preferably 0.1 millequivalents or less per 1 g, of the resin. Furthermore, as can be seen in Japanese Patent Application Laid-Open No. H02-153904, it is also possible to obtain a glutarimide-based resin through imidization using a resin usually composed of N-methylacrylamide and methacrylic acid methyl ester.

The glass transition temperature (Tg) of the glutar-based resin is preferably 110° C. to 160° C., more preferably 115° C. to 160° C., and still more preferably 120° C. to 160° C.

Further, the weight average molecular weight of the glutar-based resin is preferably in a range of 50,000 to 500,000.

In the optical film of the present disclosure, other resins may be mixed in addition to the acrylic resin. The mass ratio of the acrylic resin to the other resins is preferably 70:30 to 100:0, more preferably 80:20 to 100:0, still more preferably 90:10 to 100:0, particularly preferably 98:2 to 100:0, and most preferably 100:0. When the mass ratio of the acrylic resin to the another resin is in a range of 80:20 to 100:0, the mass ratio is preferred because due to low moisture permeability, it is possible to further suppress humidity expansion of the polarizer by water which permeates the film.

—Method of Preparing Optical Film Composed of Acrylic Resin—

Hereinafter, a preparation method of film-forming a thermoplastic resin including an acrylic resin as a main component will be described in detail.

In order to film-form an optical film using an acrylic resin as a main component, for example, film raw materials are pre-blended by using the mixer publicly known in the related art, such as an omni mixer, and then the mixture obtained is extrusion-kneaded. In this case, the mixer used for the extrusion kneading is not particularly limited, but the mixer publicly known in the related art, for example, an extruder such as a single-screw extruder and a twin-screw extruder, and a pressure kneader may be used.

Examples of a method of forming a film include film formation methods publicly known in the related art, such as a solution cast method (solution casting methods), a melt extrusion method, a calendering method, and a compression formation method. In these film formation methods, the melt extrusion method is particularly suitable.

Examples of the extrusion method include a T-die method and an inflation method, and in this case, the film formation temperature may be appropriately controlled according to the glass transition temperature of the film raw materials, and is not particularly limited, but, for example, is preferably 150° C. to 350° C., and more preferably 200° C. to 300° C.

When a film is formed by the T-die method, a film having a roll shape may be obtained by attaching a T-die to the top end of a publicly known single-screw extruder or twin-screw extruder, and winding a film extruded in a film form. At this time, it is also possible to carry out a uniaxial stretching by appropriately controlling the temperature of wound rolls to stretch the film in the direction of extrusion. Further, it is also possible to carry out simultaneous biaxial stretching or sequential biaxial stretching by stretching the film in a direction perpendicular to the direction of extrusion.

The optical film of the present invention is preferably a stretched film composed of an acrylic resin. When the film is a stretched film, the film may be either a uniaxial stretched film or a biaxial stretched film. When the film is a biaxial stretched film, the film may be either a simultaneously biaxially stretched film or a sequentially biaxially stretched film. When the film is biaxially stretched, mechanical strength of the film is improved, thereby improving the performance of the film.

When an acrylic resin is the aforementioned acrylic resin having a cyclic structure in a main chain thereof, it is possible to obtain a film in which optical isotropy is maintained because an increase in phase difference may be suppressed even though the film is stretched by mixing the other thermoplastic resins.

The thickness of the optical film composed of an acrylic resin is preferably 5 μm to 80 μm, and more preferably 10 μm to 40 μm. When the thickness is 5 μm or more, the film strength may be improved, and furthermore, deterioration in durability, such as crimp may be suppressed, which is preferred. When the thickness is 80 μm or less, in addition to securing transparency of the film, appropriate moisture permeability may be secured, which is preferred.

The optical film of the present invention is composed of an acrylic resin, and the tensile elastic modulus (EMD) in a machine direction (MD direction) and the tensile elastic modulus (ETD) in a direction (TD direction) perpendicular to the machine direction satisfy the relationship of Equation (1).

EMD/ETD<0.8 Equation (1)

The relationship is more preferably 0.5<EMD/ETD<0.8, still more preferably 0.6<EMD/ETD<0.79, and most preferably 0.73<EMD/ETD<0.78.

The tensile elastic modulus of the optical film of the present invention in a machine direction (MD direction) is preferably 1.2×10⁹ to 4.0×10⁹ N/m² (1.2 GPa to 4.0 GPa), and the tensile elastic modulus of the optical film of the present invention in a direction (TD direction) perpendicular to the machine direction is preferably 1.5×10⁹ to 5.0×10⁹ N/m². Furthermore, the tensile elastic modulus in a machine direction (MD direction) is more preferably 2.0×10⁹ to 3.5×10⁹ N/m², and the tensile elastic modulus in a direction (TD direction) perpendicular to the machine direction is more preferably 2.5×10⁹ to 4.4×10⁹ N/m².

In the optical film of the present invention, it is preferred that the film in-plane retardation value (Re) of the film represented by Re=(nx−ny)×d is 0 nm≦Re<20 nm 0 nm≦Re≦15 nm is more preferred, and 0 nm≦Re≦10 nm is still more preferred.

In the optical film of the present invention, it is preferred that the retardation value (Rth) in a thickness-direction of the film represented by Rth=((nx+ny)/2−nz)×d is |Rth|≦25 nm. |Rth|≦20 nm is more preferred, |Rth|≦10 nm is still more preferred, and −10 nm≦Rth≦5 nm is most preferred.

In the present specification, Re (λ, nm) and Rth (λ, nm) represent an in-plane retardation and a retardation in a thickness-direction at a wavelength of λ (unit; nm), respectively. Re (λ, nm) is measured by irradiating with an incident light having a wavelength of λ nm to the normal direction of the film using KOBRA 21ADH or WR (manufactured by Oji Scientific Instruments Inc.). In the selection of the measurement wavelength λ nm, measurement may be performed by replacing a wavelength selective filter manually or converting measured values using a program or the like. When a film to be measured is represented by a uniaxial or biaxial refractive index ellipsoid, Rth (λ, nm) is calculated by the following method.

A total of six points of the Re (λ, nm) are measured by irradiating with an incident light having a wavelength of λ nm from each of the inclined directions at an angle increasing in 10° step increments up to 50° in one direction from the normal direction of the film with respect of the normal direction of the film by using the in-plane slow axis (decided by KOBRA 21ADH or WR) as an inclined axis (rotation axis) (when there is no slow axis, any in-plane direction of the film is used as a rotation axis), and then Rth (λ, nm) is calculated by KOBRA 21ADH or WR based on the retardation value measured, the assumed value of the average refractive index, and the film thickness value inputted.

When λ, is not particularly described and only described with Re and Rth in the above description, the values indicate those measured by using light having a wavelength of 590 nm Further, in the case of a film having a direction in which a retardation value is zero at a certain tilt angle from the normal direction by taking the in-plane slow axis as a rotation axis, a retardation value at a tilt angle greater than that certain tilt angle is changed into a minus sign, and then is calculated by KOBRA 21ADH or WR.

Meanwhile, retardation values are measured in any inclined two directions by taking the slow axis as an inclined axis (rotation axis) (when there is no slow axis, any in-plane direction of the film will be taken as a rotation axis), and then the Rth may also be calculated based on the retardation values, the assumed value of the average refractive index, and the film thickness inputted and from the following Equations (3) and (4).

$$Equation ( 3 )$$

$$Re ( θ ) = [ nx - \frac{ny \times nz}{{\sqrt{{\{ ny sin ( {sin}^{- 1} ( \frac{sin ( - θ )}{nx} ) ) \}}^{2} + \{ nz cos ( {sin}^{- 1} ( \frac{sin ( - θ )}{nx} ) ) \}}}^{2}} ] \times \frac{d}{cos \{ {sin}^{- 1} ( \frac{sin ( - θ )}{nx} ) \}}$$

[In the equation, Re (θ) represents a retardation value in a direction inclined by an angle (θ) from the normal direction. Further, nx represents a refractive index in an in-plane slow axis direction; ny represents a refractive index in an in-plane direction orthogonal to nx, nz represents a refractive index in a thickness-direction perpendicular to nx and ny, and d represents a film thickness.]

Rth=((nx+ny)/2−nz)×d Equation(4):

In the aforementioned measurements, values described in Polymer Handbook (John Wiley & Sons, Inc.) and catalogues of various optical films may be used as the hypothetical value of the average refractive index. The average refractive index whose value is not known may be measured by an Abbe refractometer. Main values of average refractive indices of optical films are exemplified below: Cellulose acylate (1.48), cycloolefin polymer (1.52), polycarbonate (1.59), polymethyl methacrylate (1.49) and polystyrene (1.59). By inputting these average refractive indices and the film thickness, nx, ny and nz are calculated by KOBRA 21ADH or WR. From these calculated nx, ny, and nz, Nz=(nx−nz)/(nx−ny) is further calculated.

<Polarizing Plate>

A polarizing plate of the present invention has a polarizer and the optical film of the present invention on at least one surface of the polarizer. It is preferred that the polarizing plate of the present invention has the optical film of the present invention on both surfaces of the polarizer.

It is preferred that the polarizer and the optical film of the present invention as a protective film of the polarizer, and as a configuration of the polarizing plate, a protective film/a polarizer/a protective film, a protective film/a polarizer, or a protective film/a polarizer/a functional layer is preferred.

With respect to a polarizing plate protective film for constituting the polarizing plate of the present invention, there is no particular limitation on a material, which may be used in the protective film other than the optical film of the present invention. The protective film may be a layer or a film (hereinafter, also collectively referred to as “film” in some cases) made of various polymers, and it is possible to use, for example, cellulose acylate-based polymers, polycarbonate-based polymers, polyester-based polymers such as polyethylene terephthalate and polyethylene naphthalate, acrylic polymers such as polymethyl methacrylate, styrene-based polymers such as polystyrene or acrylonitrile.styrene copolymers (AS resins), and the like. In addition, one or two or more polymers are selected from polyolefin-based polymers, such as polyolefins such as polyethylene and polypropylene and ethylene.propylene copolymers, cycloolefin-based polymers, vinyl chloride-based polymers, amide-based polymers such as nylon and aromatic polyamides, imide-based polymers, sulfone-based polymers, polyether sulfone-based polymers, polyether ether ketone-based polymers, polyphenylene sulfide-based polymers, chloride vinylidene-based polymers, vinyl alcohol-based polymers, vinyl butyral-based polymers, arylate-based polymers, polyoxymethylene-based polymers, epoxy-based polymers, or polymer mixtures of the above polymers and the like, and the polymers may be used as main components to prepare a polymer layer or film. Furthermore, the protective film may be a layer formed by polymerizing a rod-like liquid crystal or a discotic liquid crystal having a polymerizable group in a predetermined alignment state, and fixing the liquid crystal.

In polarizing plate of the present invention, when the other optical film is adhered on a surface opposite to the surface on which the polarizer is adhered to the optical film of the present invention, the other optical film may have a functional layer. In order to improve adhesion with the polarizer or another functional layer, another optical film may have an easily adhesive layer as a functional layer.

The polarizing plate of the present invention may be manufactured by a general method. For example, a method of laminating a polarizer and the optical film of the present invention is used.

In the lamination, a typical adhesive bond is used. An adhesive bond layer between the polarizer and the polarizing plate protective films on both surfaces may be set to have a thickness of 0.01 μm to 30 μm, and preferably 0.01 μm to 10 μm, and more preferably 0.05 μm to 5 μm. Since the thickness of the adhesive bond layer in this range does not cause lifting nor peeling between the polarizing plate protective film and the polarizer to be laminated, bond strength without a practical problem may be obtained.

Examples of one preferred adhesive bond include water-based adhesive bonds, that is, those in which adhesive bond components are dissolved or dispersed in water, and an adhesive bond composed of a polyvinyl alcohol-based resin aqueous solution is preferably used.

In the adhesive bond composed of a polyvinyl alcohol-based resin aqueous solution, examples of the polyvinyl alcohol-based resin include vinyl alcohol homopolymers obtained by performing saponification of polyvinyl acetate, which is a homopolymer of vinyl acetate, and vinyl alcohol-based copolymers obtained by performing saponification of a copolymer of vinyl acetate and another monomer copolymerizable therewith, and modified polyvinyl alcohol-based polymers obtained by partial modification of hydroxyl groups thereof.

To the adhesive bond, multivalent aldehydes, water-soluble epoxy compounds, melamine-based compounds, zirconia compounds, zinc compounds, glyoxylic acid salts and the like may be added as a crosslinking agent. When the water-based adhesive bond is used, the adhesive bond layer obtained therefrom has a thickness of usually 1 μm or less.

Examples of another preferred adhesive bond include curable adhesive bond compositions containing epoxy compounds cured by irradiation with actinic energy rays or heating. Here, the curable epoxy compounds have at least two epoxy groups in a molecule thereof. In this case, adhesion of the polarizer to the protective film may be performed by a method of curing curable epoxy compounds contained in the adhesive bond by irradiating actinic energy rays or imparting heat to an applied layer of the adhesive bond composition. The curing of the epoxy compound is generally performed by cationic polymerization of the epoxy compound. Further, from the viewpoint of productivity, it is preferred that the curing is performed by irradiation with actinic energy rays.

When a curable adhesive bond is used, the adhesive bond layer obtained therefrom has a thickness of usually 0.5 μm to 5 μm.

When the curable adhesive bond is used, the curable adhesive bond is cured by adhering a film by means of an adhering roll, and then drying the film if necessary, and irradiating with actinic energy rays or imparting heat. A light source of the actinic energy rays is not particularly limited, but actinic energy rays having a light emission distribution at a wavelength of 400 μm or less is preferred, and specifically, a low-pressure mercury lamp, a medium-pressure mercury lamp, a high-pressure mercury lamp, an ultra high-pressure mercury lamp, a chemical lamp, a black light lamp, a microwave-excited mercury lamp, a metal halide lamp and the like are preferably used.

From the viewpoint of weather resistance, refractive index, cationic polymerizability and the like, it is preferred that the epoxy compounds contained in the curable adhesive bond composition do not include an aromatic ring in a molecule thereof. Examples of the epoxy compounds which do not include an aromatic ring in a molecule thereof include hydrogenated epoxy compounds, alicyclic epoxy compounds, aliphatic epoxy compounds and the like. The epoxy compounds suitably used in the curable adhesive bond composition are described in detail, for example, in Japanese Patent Application Laid-Open No. 2004-245925.

In adhering the optical film of the present invention to the polarizer with an adhesive bond, the optical film of the present invention may be subjected to surface treatment (for example, glow discharge treatment, corona discharge treatment, and ultraviolet (UV) treatment) or formation of an easily adhesive layer on a surface facing the polarizer for the purpose of enhancing adhesion strength. It is possible to use materials, formation methods and the like of an easily adhesive layer described in Japanese Patent Application Laid-Open No. 2007-127893.

When a film other than the optical film of the present invention is used as a protective film, for example, in an aspect in which a cellulose acylate film (cellulose acylate-based polymer layer) is used, a device may be manufactured by adhering a back surface of the cellulose acylate film to the polarizer. In an aspect in which a water-based adhesive bond is used in the adhesion of the cellulose acylate film to the polarizer, it is preferred that an adhesion surface of the cellulose acylate film is subjected to alkali saponification treatment. Further, in the adhesion, a complete saponification type polyvinyl alcohol aqueous solution may be used.

As the polarizer, a polarizer prepared by the method publicly known in the related art may be used, and a polyvinyl alcohol-based polarizer is preferred. For example, a polarizer obtained by treating a film, which is composed of a hydrophilic polymer such as an ethylene-modified polyvinyl alcohol having a polyvinyl alcohol or ethylene unit of 1% by mol to 4% by mol, a polymerization degree of 2,000 to 4,000 and a saponification degree of 99.0% by mol to 99.99% by mol with a dichroic dye such as iodine and stretching the film, or a polarizer obtained by treating a plastic film such as vinyl chloride and orienting the film is used.

Examples of a method of obtaining a polarizer film having a thickness of 10 μm or less, by stretching and dyeing a laminated film in which a polyvinyl alcohol layer is formed on a substrate, include methods described in Japanese Patent Nos. 5048120, 5143918, 5048120, 4691205, 4751481 and 4751486, and these techniques publicly known relating to the polarizer may also be preferably used in the polarizing plate of the present invention.

<Functional Layer>

It is preferred that the polarizing plate of the present invention has a functional layer on at least one surface of the optical film of the present invention, which is a protective film. Examples of the functional layer include a pattern phase difference layer for displaying a 3-D image, a λ/4 layer, a hardcoat layer, an antireflection layer, an antiglare layer, an antistatic layer, an optically anisotropic layer, an easily adhesive layer and the like. Each functional layer may be used either alone or in combination. In addition, particularly in an aspect in which a pattern phase difference layer or a λ/4 layer is formed on the optical film of the present invention, preferred is an aspect in which a hardcoat layer is formed on another surface of the optical film of the present invention, or on the pattern phase difference layer or the λ/4 layer. Furthermore, in an aspect in which a hardcoat layer is formed on a pattern phase difference layer or a λ/4 layer, it is preferred that a layer disposed on the viewing side or the hardcoat layer has UV absorption ability rather than the hardcoat layer or the pattern phase difference layer, or the λ/4 layer.

In the case of a configuration in which the polarizing plate of the present invention has a protective film/a polarizer/a functional layer, that is, the polarizing plate of the present invention sandwiches the polarizer with the optical film of the present invention as the protective film and the functional layer, in a liquid crystal display device, in an aspect in which the functional layer is disposed on a side close to a liquid crystal cell, it is preferred that the functional layer is a λ/4 layer, an optically anisotropic layer, a hardcoat layer, an antistatic layer, and an easily adhesive layer.

<Pattern Phase Difference Layer>

In a pattern phase difference layer, at least one of an in-plane slow axis direction and an in-plane retardation includes a first phase difference region and a second phase difference region, which are different from each other, and the first and second phase difference regions are alternately disposed in the in-plane, and have a boundary portion therebetween. An example thereof is an optically anisotropic layer in which the first and second phase difference regions each have an Re of approximately λ/4, and in-plane slow axes are orthogonal to each other. Various methods may be used in the formation of the pattern phase difference layer, but it is preferred that the pattern phase difference layer is formed by polymerizing a rod-like liquid crystal having a polymerizable group in a horizontal alignment state and a discotic liquid crystal in a vertical alignment state, and fixing the liquid crystals.

In general, liquid crystal compounds may be classified into a rod-like type and a discotic type according to the shape thereof. Further, each includes low-molecular types and polymer types. The polymer generally refers to a type having a polymerization degree of 100 or more (Polymer Physics-Phase Transition Dynamics), by Masao Doi, p. 2, published by Iwanami Shoten, Publishers, 1992). In a pattern optical anisotropic layer used in the present invention, any type of liquid crystalline compounds may be used, but it is preferred that a rod-like liquid crystalline compound or a discotic liquid crystalline compound is used. It is also possible to use two or more kinds of rod-like liquid crystalline compounds, two or more kinds of discotic liquid crystalline compounds, or a mixture of a rod-like liquid crystalline compound and a discotic liquid crystalline compound. It is more preferred that the pattern optical anisotropic layer is formed using a rod-like liquid crystalline compound having a reactive group or a discotic liquid crystalline compound having a reactive group, because such a compound may reduce a temperature change or a humidity change, and it is still more preferred that the pattern optical anisotropic layer is formed using at least one compound having two or more reactive groups in a single liquid crystalline molecule. The liquid crystalline compound may be used in the form of a mixture of two or more kinds of compounds, and in this case, it is preferred that at least one of the compounds has two or more reactive groups.

As the rod-like crystalline compounds, for example, compounds described in Japanese Unexamined Patent Application Publication No. H11-513019 or Japanese Patent Application Laid-Open No. 2007-279688 may be preferably used, and as the discotic liquid crystalline compounds, for example, compounds described in Japanese Patent Application Laid-Open No. 2007-108732 or 2010-244038 may be preferably used, but examples are not limited thereto.

It is also preferred that the liquid crystalline compound has two or more kinds of reactive groups which have different polymerization conditions from each other. In this case, a phase difference layer including a polymer having an unreacted reactive group may be manufactured by polymerizing only a specific kind of reactive group among a plurality of reactive groups by selecting a condition. The polymerization condition to be used may be a wavelength region of ionized radiation used for the polymerization and fixation or difference between mechanisms of polymerization to be used, but preferably, the condition may be a combination of a radically reactive group and a cationically reactive group, which may be controlled according to the kind of initiator to be used. The combination of an acrylic group and/or a methacrylic group as the radically reactive group and a vinyl ether group, an oxetane group, and/or an epoxy group as the cationic group easily controls the reactivity, which is particularly preferred.

The optically anisotropic layer may be formed by various methods using an alignment film, but the preparation method thereof is not particularly limited.

A first aspect is a method of making a predetermined alignment controlling action predominant, the method predominant, by using multiple actions that affect the alignment control of liquid crystal, and then removing any of those actions through an external stimulation (heat treatment and the like). For example, the liquid crystal may be aligned in a predetermined alignment state by a combined action of the alignment controlling capability by the alignment film and the alignment controlling capability of an alignment controlling agent which is added to a liquid crystalline compound, and then the alignment state is fixed to form one phase difference region, and after that, by an external stimulation (heat treatment and the like), any of the actions (for example, the action by the alignment controlling agent) may be removed while another alignment controlling actions (the action by the alignment film) may become predominant, and accordingly, the another alignment state may be implemented, and fixed to form the other phase difference region. For example, a predetermined pyridinium compound or a predetermined imidazolium compound is localized on the surface of the hydrophilic polyvinyl alcohol alignment film because a pyridinium group or an imidazolium group is hydrophilic. In particular, when an amino group as a substituent for the acceptor of a hydrogen atom is substituted, the intermolecular hydrogen bonding also occurs between the pyridinium group and polyvinyl alcohol, and therefore, the pyridinium group may be localized on the surface of the alignment film at a higher density, and simultaneously, owing to the effect of the hydrogen bonding, a pyridinium derivative is aligned in a direction orthogonal to the main chain of polyvinyl alcohol, and as a result, the orthogonal alignment of liquid crystal is promoted with respect to the rubbing direction. The pyridinium derivative has a plurality of aromatic rings in a molecule thereof, and thus provides a strong intermolecular π-π interaction with the aforementioned liquid crystal, especially with the discotic liquid crystalline compound, thereby inducing orthogonal alignment of a discotic liquid crystal in the vicinity of the alignment film interface. In particular, when a hydrophobic aromatic ring is linked to the hydrophilic pyridinium group, the compounds also have an effect of inducing vertical alignment owing to the hydrophilic effect of the ring therein. However, when the compound is heated at a temperature higher than a certain temperature, the hydrogen bonding may be broken and the density of the pyridinium compound on the surface of the alignment film may be lowered, and the aforementioned effect is lost. As a result, the liquid crystal is aligned by the controlling force of the rubbing alignment film itself and is in a parallel alignment state. The details of the method are described in Japanese Patent Application Laid-Open No. 2012-8170, and the content thereof is incorporated herein by reference.

A second aspect is an aspect using a patterned alignment film. In the aspect, a patterned alignment film having different alignment controlling capabilities is formed, and a liquid-crystal compound is disposed thereon so that the liquid crystal is aligned on the alignment film. The alignment of the liquid crystal is controlled according to each alignment controlling capability of the patterned alignment film, thereby achieving different alignment states. By fixing each alignment state, patterns of first and second phase difference regions are formed according to the pattern of the alignment film. The patterned alignment film may be formed using a printing method, a mask rubbing for a rubbing alignment film, a mask exposure for a photo-alignment film or the like. Furthermore, the patterned alignment film may also be formed by uniformly forming an alignment film, and separately printing an additive (for example, the aforementioned onium salt and the like) which affects the alignment controlling capability in a predetermined pattern. A method of using the printing method is preferred in that a large-scale facility is not necessary, or the preparation is facilitated. The details of the method are described in Japanese Patent Application Laid-Open No. 2012-032661, and the content thereof is incorporated herein by reference.

The first and second aspects may be used in combination. One example is an example of adding a photo acid generating agent to the alignment film. In this example, a photo acid generating agent is added to the alignment film, and then pattern-exposed to form a region where the photo acid generating agent is decomposed to generate an acid compound and a region where an acid compound is not generated. At a portion on which light is not irradiated, the photo acid generating agent is kept almost undecomposed, and the interaction between the alignment film material, the liquid crystal, and the alignment controlling agent added thereto if desired governs the alignment state, and accordingly, the liquid crystal is aligned in a direction in which the slow axis thereof is orthogonal to the rubbing direction. When light is irradiated on the alignment film to generate an acidic compound, the aforementioned interaction is no more predominant, and the rubbing direction for the rubbing alignment film governs the alignment state, and accordingly, the liquid crystal is aligned in parallel so that the slow axis thereof is in parallel to the rubbing direction. As the photo acid generating agent to be used in the alignment film, a water-soluble compound is preferably used. Examples of the photo acid generating agent usable herein include the compounds described in Prog. Polym. Sci., 23, 1485 (1998). As the photo acid generating agent, pyridinium salts, iodonium salts and sulfonium salts are particularly preferably used. The details of the method are described in Japanese Patent Application Laid-Open No. 2012-150428, and the content thereof is incorporated herein by reference.

(Shapes of First Region and Second Region)

The optical film of the present invention has a first phase difference region (hereinafter, simply referred to as a first region) and a second phase difference region (hereinafter, simply referred to as a second region), of which birefringence is different from each other, and an optically anisotropic layer (hereinafter, also referred to as a pattern phase difference) in which the first phase difference region and the second phase difference region are alternately patterned for every one line. It is preferred that the first region and the second region have a band-like shape with the lengths of the short sides of the regions almost identical to each other, and are repetitively and alternately patterned from the viewpoint of being used for a 3D stereoscopic image display system.

In the optical film of the present invention, it is preferred that the slow axis of the first region and the slow axis of the second region are approximately orthogonal to each other from the viewpoint that the polarization state of light passing through the first region and the second region may be switched from the linearly polarized light to the circularly polarized light or from the circularly polarized light to the linearly polarized light when a 3D image is displayed. Further, in the optical film of the present invention, it is more preferred that the slow axis of the first region and the slow axis of the second region are orthogonal to each other from the viewpoint that the polarization state of light passing through the first region and the second region may be switched from the linearly polarized light to the circularly polarized light or from the circularly polarized light to the linearly polarized light, without being elliptically polarized when a 3D image is displayed.

In the optical film of the present invention, it is preferred that the direction of the long side of the pattern and the direction in which the sound velocity of the support becomes the maximum are approximately orthogonal to each other from the viewpoint that the misalignment of the pattern region and the pixel may be reduced and the crosstalk may be suppressed.

(Retardation)

As described above, it is preferred that a pattern phase difference layer having a function of converting the linearly polarized light into the circularly polarized light, or the circularly polarized light into the linearly polarized light has a ¼ retardation of the wavelength. In general, the ¼ retardation is called as a ¼ wavelength plate, and at a visible light wavelength of 550 μm, Re=137.5 μm becomes an ideal value.

A pattern phase difference layer of converting the linearly polarized light into the circularly polarized light or the circularly polarized light into the linearly polarized light does not always have a ¼ retardation. For example, the pattern phase difference layer may have a −¼ or ¾ retardation of the wavelength, and may have the retardation represented by a general formula, a ¼±n/2 (n is an integer) retardation of the wavelength.

For the patterning in which the slow axis of the first region and the slow axis of the second region are orthogonal to each other, regions having a −¼ or ¼ retardation of the wavelength may be alternately formed. At this time, the slow axes of the respective regions are almost orthogonal to each other. Furthermore, ¼ and ¾ retardations of the wavelength may be patterned, and at this time, the slow axes of the respective regions become almost parallel to each other. However, the rotation directions of the circularly polarized light of the respective regions are opposite to each other.

For the patterning of the ¼ and ¾ retardation of the wavelength, ½ or −½ retardation of the wavelength may be formed after the ¼ of the wavelength is formed on the entire surface.

When the optical film of the present invention is allowed to have the ¼ retardation of the wavelength, a Re (550) value of the first region included in the optical film and a Re (550) value of the second region included in the optical film are preferably 30 nm to 250 nm, more preferably 50 nm to 230 nm, particularly preferably 100 nm to 200 nm, more particularly preferably 105 nm to 180 nm, still more preferably 115 nm to 160 nm, and more particularly preferably 120 nm to 150 nm.

During the 3D image display, the entire Re (550) of the pattern phase difference layer and the support is preferably 110 nm to 165 nm, more preferably 110 nm to 155 nm, and still more preferably 120 nm to 145 nm from the viewpoint that the polarization state of light passing through the first region and the second region may be switched from the linearly polarized light to the circularly polarized light or from the circularly polarized light to the linearly polarized light. In particular, it is preferred that the entire Re (550) of the pattern phase difference layer and the support is within the range, and the slow axes of the first region and the second region are approximately orthogonal to each other from the viewpoint that the polarization state of an image for the right eye and an image for the left eye may be changed with good accuracy.

<λ/4 Layer>

A λ/4 layer is an aspect of only the first phase difference region described in the section of the aforementioned pattern phase difference layer. That is, the λ/4 layer is not an aspect of having two regions in which birefringence is different from each other, but an aspect of having regions in which birefringence is uniform. Preferred materials or retardation ranges are the same as those of the pattern phase difference layer.

<Optically Anisotropic Layer>

An optically anisotropic layer refers to a layer composed of the various polymers in a predetermined alignment state, or a layer formed by polymerizing a rod-like liquid crystal or a discotic liquid crystal having a polymerizable group in a predetermined alignment state, and fixing the liquid crystal. As the rod-like liquid crystal or the discotic liquid crystal having a polymerizable group, a material such as the pattern phase difference layer may be used.

<Hardcoat Layer>

The thickness of the hardcoat layer is preferably 0.1 μm to 6 μm, and more preferably 3 μm to 6 μm. By having a thin hardcoat layer in the range, an optical film including a hardcoat layer, in which improvement of physical properties such as suppression of brittleness or curls, lightness and reduction in preparation costs have been achieved, is manufactured. Furthermore, when a substrate film has a large elastic modulus, a pencil hardness may be significantly increased by setting the elastic modulus to the specific elastic modulus range or more.

The hardcoat layer used in the present invention is a layer for imparting hardness or scratch resistance to a film. The hardcoat layer may be formed, for example, by applying an application composition on the optical film of the present invention, which is a substrate film, and curing the composition. Further, for the purpose of adding other functions, other functional layers may be laminated on the hardcoat layer. In addition, by adding a filler or an additive to the hardcoat layer, mechanical, electrical and optical physical performances, or chemical performances such as water repellency•oil repellency may also be imparted to the hardcoat layer itself.

The thickness of the hardcoat layer is preferably 0.1 μm to 6 μm, and more preferably 3 μm to 6 μm. By having a thin hardcoat layer in the range, an optical film including a hardcoat layer, in which improvement of physical properties such as suppression of brittleness or curls, lightness and reduction in preparation costs have been achieved, is manufactured. Furthermore, when a substrate film has a large tensile elastic modulus in a TD direction, a pencil hardness may be significantly increased by setting the tensile elastic modulus to the specific elastic modulus range or more.

It is preferred that the hardcoat layer is formed by curing a curable composition. It is preferred that the curable composition is prepared as a liquid application composition. One example of the application composition includes a monomer or an oligomer for a matrix forming binder, polymers, and an organic solvent. A hardcoat layer may be formed by applying an application composition, and then curing the composition. In the curing, a crosslinking reaction or a polymerization reaction may be used.

(Monomer or Oligomer for Matrix Forming Binder)

Examples of an available monomer or oligomer for a matrix forming binder include ionized radiation curable polyfunctional monomers and polyfunctional oligomers. It is preferred that the polyfunctional monomers or polyfunctional oligomers are monomers capable of undergoing a crosslinking reaction or a polymerization reaction. The functional group of the ionized radiation curable polyfunctional monomer or the polyfunctional oligomer is preferably a photopolymerizable, electron beam polymerizable, or radiation polymerizable functional group, and among them, the photopolymerizable functional group is preferred.

Examples of the photopolymerizable functional group include unsaturated polymerizable functional groups such as a (meth)acryloyl group, a vinyl group, a styryl group, and an allyl group, or ring-opening polymerization type polymerizable functional groups such as epoxy-based compounds, and among them, a (meth)acryloyl group is preferred.

Specific examples of the photopolymerizable polyfunctional monomer having a photopolymerizable functional group include:

(meth)acrylic acid diesters of alkylene glycol, such as neopentyl glycol acrylate, 1,6-hexanediol(meth)acrylate and propylene glycol di(meth)acrylate; (meth)acrylic acid diesters of polyoxyalkylene glycol, such as triethylene glycol di(meth)acrylate, dipropylene glycol di(meth)acrylate, polyethylene glycol di(meth)acrylate and polypropylene glycol di(meth)acrylate;

(meth)acrylic acid diesters of polyhydric alcohol, such as pentaerythritol di(meth)acrylate;

(meth)acrylic acid diesters of ethylene oxide or propylene oxide adduct, such as 2,2-bis {4-(acryloxy.diethoxy)phenyl} propane and 2-2-bis {4-(acryloxy.polypropoxy)phenyl}propane; and the like.

Urethane(meth)acrylates, polyester(meth)acrylates, is ocyanuric acrylates and epoxy(meth)acrylates may also be preferably used as a photopolymerizable polyfunctional monomer.

Among those described above, esters of a polyhydric alcohol and (meth)acrylic acid are preferred, and polyfunctional monomers having three or more (meth)acryloyl groups in one molecule thereof are more preferred.

Specific examples thereof include (di)pentaerythritol tri(meth)acrylate, (di)pentaerythritol tetra(meth)acrylate, (di)pentaerythritol penta(meth)acrylate, (di)pentaerythritol hexa(meth)acrylate, tripentaerythritol triacrylate, tripentaerythritol hexatriacrylate, trimethylolpropane tri(meth)acrylate, trimethylolethane tri(meth)acrylate, ditrimethylolpropane tetra(meth)acrylate, EO-modified trimethylolpropane tri(meth)acrylate, PO-modified trimethylolpropane tri(meth)acrylate, EO-modified phosphoric acid tri(meth)acrylate, 1,2,4-cyclohexane tetra(meth)acrylate, pentaglycerol triacrylate, 1,2,3-cyclohexane tetramethacrylate, polyester polyacrylate, caprolactone-modified tris(acryloxyethyl)isocyanurate and the like.

In the present specification, “(meth)acrylate”, “(meth)acrylic acid” and “(meth)acryloyl” mean “acrylate or methacrylate”, acrylic acid or methacrylic acid” and “acryloyl or methacryloyl”, respectively.

For resins having three or more (meth)acryloyl groups, examples thereof also include polyester resins having a relatively low molecular weight, as well as polyether resins, acrylic resins, epoxy resins, urethane resins, alkyd resins, spiroacetal resins, polybutadiene resins, polythiol polyene resins, oligomers or prepolymers of polyfunctional compounds such as polyhydric alcohols, and the like.

For specific compounds of polyfunctional acrylate-based compounds having three or more (meth)acryloyl groups, reference may be made to [0096] of Japanese Patent Application Laid-Open No. 2007-256844 and the like.

Examples of urethane acrylates include urethane acrylate-based compounds obtained by reacting hydroxyl group-containing compounds such as alcohol, polyol and/or hydroxyl group-containing acrylate with isocyanates, or if necessary, esterifying the polyurethane compound obtained through the reaction with (meth)acrylic acid.

For specific examples of specific compounds, reference may be made to [0017] of Japanese Patent Application Laid-Open No. 2007-256844 and the like.

Use of isocyanuric acrylates is preferred because the curling may be reduced. Examples of isocyanuric acrylates include isocyanuric diacrylates and isocyanuric triacrylates; and for specific examples of those compounds, reference may be made to [0018] to [0021] of Japanese Patent Application Laid-Open No. 2007-256844 and the like.

An epoxy-based compound may be used in the hardcoat layer for reducing the shrinkage of the layer through curing. As the epoxy group-containing monomers to constitute the compound, usable are monomers having two or more epoxy groups in one molecule thereof, and examples of those monomers include epoxy-based monomers described in Japanese Patent Application Laid-Open Nos. 2004-264563, 2004-264564, 2005-37737, 2005-37738, 2005-140862, 2005-140863, 2002-322430 and the like. In addition, it is also preferred that compounds having both epoxy and acrylic functional groups such as glycidyl(meth)acrylate are used.

(Polymer Compound)

The hardcoat layer may contain a polymer compound. Description and preferred specific examples of the polymer compound are also the same as the contents described in Japanese Patent Application Laid-Open No. 2012-215812, and the content described in the patent documents is incorporated herein.

(Curable Composition)

Description and preferred specific examples of the curable composition which may be used in the formation of the hardcoat layer are also the same as the contents described in Japanese Patent Application Laid-Open No. 2012-215812, and the content described in the patent documents is incorporated herein.

(Properties of Hardcoat Layer)

It is preferred that the hardcoat layer has excellent scratch resistance. Specifically, when a pencil hardness test as an index of scratch resistance is performed, it is preferred that 3H or higher is achieved.

The polarizing plate of the present invention may have other layers along with the optical film of the present invention and the hardcoat layer in order to exhibit a function suitable for each use. For example, the polarizing plate of the present invention may have an antireflection layer, an antistatic layer, an antifouling layer and the like in addition to an antiglare layer and a clear hardcoat layer

Since fingerprint resistance and antifouling property are required particularly for image display screens having various types of touch panels recently supplied, it is also useful to form a fingerprint resistant layer or an antifouling property layer on the optical film of the present invention.

For the fingerprint resistant layer and the antifouling property layer, reference may be made to, for example, Japanese Patent Nos. 4517590 and 4638954 and International Publication Nos. WO2010/090116 and WO2011/105594.

There is no limitation even on the image display device, and the image display device may be a liquid crystal display device including a liquid crystal cell, an organic EL image display device including an organic EL layer, or a plasma display device. A cellulose acylate-based polymer layer, a polyester-based polymer layer, an acrylic polymer layer, a cycloolefin-based polymer layer, and a layer composed of a composition including a liquid crystal compound have good adhesibility with a polarizer, and thus are suitable for use in a liquid crystal display device including a polarizing plate as an essential member.

In the manufacture of the polarizing plate, when the optical film of the present invention has an in-plane slow axis, it is preferred that the in-plane slow axis is adhered to the transmission axis of the polarizer so as to be parallel or orthogonal to each other.

[Liquid Crystal Display Device]

The liquid crystal display device of the present invention has at least one polarizing plate of the present invention.

In the polarizing plate, an example of methods of disposing the optical film of the present invention is a surface protective film of the polarizing plate, in which the optical film of the present invention is disposed on the outer side of the polarizer (that is, disposed so as to be further distant from the liquid crystal cell than the polarizer of the polarizing plate), in a state where the optical film of the present invention does not have a functional layer such as a hardcoat layer. Another example of methods of disposing the optical film of the present invention is a surface protective film of the polarizing plate in the polarizing plate on the display surface side, in which the optical film of the present invention is disposed on the outer side of the polarizer (that is, disposed so as to be further distant from the liquid crystal cell than the polarizer of the polarizing plate), in a state where the optical film of the present invention has a functional layer such as a hardcoat layer. Furthermore, in the liquid crystal display device of the present invention, it is also preferred that the polarizing plate is disposed such that the optical film of the present invention becomes closer to the liquid crystal cell than the protective film on another side.

With respect to the other configurations, any configuration of a publicly known liquid crystal display device may be adopted. There is no particular limitation even on the mode thereof, and it is possible to configure the liquid crystal display device of the present invention as a liquid crystal display device of various display modes such as TN (twisted nematic), IPS (in-plane switching), FLC (ferroelectric liquid crystal), AFLC (anti-ferroelectric liquid crystal), OCB (optically compensatory bend), STN (supper twisted nematic), VA (vertically aligned) and HAN (hybrid aligned nematic).

The liquid crystal display device of the present invention is preferably a transmissive liquid crystal display device, the transmissive liquid crystal display device is usually includes a backlight and two polarizing plates in which the liquid crystal cell and the transmission axis are orthogonal to each other, and the two polarizing plates are adhered to the viewing side of the liquid crystal cell and the backlight side through an adhesive layer.

The aforementioned liquid crystal cell has a liquid crystal layer and two glass substrates provided on both sides of the liquid crystal layer.

As a glass substrate for a liquid crystal display device, silicate glass is used, preferably, silica glass and borosilicate glass are used, and most preferably, alkali-free borosilicate glass is used. When alkali components are contained in a glass substrate for a liquid crystal display device, alkali components are eluted, and thus there is concern in that a TFT may be damaged. Meanwhile, the alkali-free borosilicate glass herein refers to glass in which alkali components are not substantially included, and specifically to glass including alkali components in an amount of 1,000 ppm or less. As for the content of alkali components in the present invention, alkali components are present in an amount of preferably 500 ppm or less, and more preferably 300 ppm or less.

The glass substrate for a liquid crystal display device is an approximately rectangular plate-like body when viewed from the flat surface, and preferably has a glass substrate having a plate thickness of 0.01 mm to 1.1 mm. When the plate thickness is 0.01 mm or more, it is difficult for the glass substrate to be affected by interference of light or internal distortion and the like caused by deformation of a glass substrate for display to be evaluated, and when the plate thickness is 1.1 mm or less, it is difficult for brightness to be reduced during the evaluation. A more preferred plate thickness is 0.1 mm to 0.7 mm, and a still more preferred plate thickness is 0.1 mm to 0.5 mm

The method of adhering the polarizing plate of the present invention to the liquid crystal display device is not particularly limited, and a polarizing plate having a size of a display surface of the liquid crystal display device may be prepared, and then may be each adhered to both surfaces of the liquid crystal cell.

As the method of adhering the polarizing plate of the present invention to the liquid crystal display device, a roll-to-panel manufacturing method may also be used, and is preferred in terms of enhancing productivity and yield. The roll-to-panel manufacturing method is described in Japanese Patent Application Laid-Open Nos. 2011-48381 and 2009-175653, Japanese Patent Nos. 4628488 and 4729647, International Publication Nos. 2012/014602 and 2012/014571, and the like, but is not limited thereto.

The method of adhering the polarizing plate to the liquid crystal display device may also be an adhesion method including a first cutting adhesion process of using a roll in which a band-like sheet-type product of a first polarizing plate having a width corresponding to a short side of a display surface of a liquid crystal display device is wound to cut the first polarizing plate into a length corresponding to a long side of the display surface of the liquid crystal display device, and then adhering the first polarizing plate to a display surface on one side of the liquid crystal cell of the liquid crystal display device, and a second cutting adhesion process of using a roll in which a band-like sheet-type product of a second polarizing plate having a width corresponding to the long side of the display surface of the liquid crystal display device is wound, to cut the second polarizing plate into a length corresponding to the short side of the display surface of the liquid crystal display device, and then adhering the second polarizing plate to a surface on the other side of the liquid crystal cell of the liquid crystal display device.

According to the method, it is possible to obtain the polarizing plates corresponding to the short side and the long side, respectively, of the display surface of the liquid crystal display device by using a roll of a polarizing plate having a width corresponding to the short side and a roll of a polarizing plate having a width corresponding to the long side, of the display surface of the liquid crystal display device to only cut the polarizing plate supplied from each roll at a predetermined interval. For this reason, by cutting the first polarizing plate into a length corresponding to the long side and cutting the second polarizing plate into a length corresponding to the short side to adhere the polarizing plates to both surfaces of the liquid crystal cell of the liquid crystal display device, two rolls having the same direction in optical anisotropy, such as adsorption axis may be used to adhere the upper and lower polarizing plates to the liquid crystal cell such that optical anisotropies of the adsorption axis and the like are orthogonal to each other.

In the adhesion by the method, it is preferred to use an adhesion system including: a supplying apparatus of a liquid crystal cell for supplying the liquid crystal cell, a supplying apparatus of a first polarizing plate for withdrawing a band-like sheet-type product from a roll in which the band-like sheet-type product of the first polarizing plate is wound, cutting the product into a predetermined length, and then supplying the product, a first adhesion apparatus for adhering the first polarizing plate, which is supplied from the supplying apparatus of the first polarizing plate, onto one surface of the liquid crystal cell, which is supplied from the supplying apparatus of the liquid crystal cell, a conveying and supplying apparatus for conveying and supplying the liquid crystal cell after adhering the first polarizing plate, a supplying apparatus of a second polarizing plate for withdrawing the band-like sheet-type product from a roll in which the belt-like sheet-type product of the second polarizing plate is wound, cutting the product into a predetermined length, and then supplying the product, and a second adhesion apparatus for adhering the second polarizing plate, which is supplied from the supplying apparatus of the second polarizing plate, onto the other surface of the liquid crystal cell, which is supplied from the conveying and supplying apparatus, in which so as for the supplying apparatus of the first polarizing plate and the supplying apparatus of the second polarizing plate to correspond to the long side and the short side of the liquid crystal cell, the one supplying apparatus cuts the polarizing plate having a width corresponding to the short side into a length corresponding to the long side, and the other supplying apparatus cuts the polarizing plate having a width corresponding to the long side into a length corresponding to the short side.

### EXAMPLES

Hereinafter, the present invention will be described in more detail with reference to the Examples. Materials, reagents, amounts and ratios of substances, operations and the like described in the following Examples may be appropriately modified without departing from the spirit of the present invention. Therefore, the scope of the present invention is not limited to the specific examples described below.

[Manufacture of Optical Film 1]

A pellet of [a mixture of 90 parts by mass of an acrylic resin having a lactone ring structure represented by the following Formula (1) {copolymerization monomer mass ratio=methyl methacrylate/2-(hydroxymethyl)methyl acrylate=8/2, lactone cyclization ratio: about 100%, content ratio of the lactone ring structure: 19.4% by mass, weight average molecular weight: 133,000, melt flow rate: 6.5 g/10 min (240° C., 10 kgf), Tg 131° C.} and 10 parts by mass of acrylonitrile-styrene (AS) resin {Toyo AS AS20, manufactured by Toyo-Styrene Co., Ltd.}; Tg 127° C.] was supplied to a twin-screw extruder and melt-extruded in a sheet form at about 280° C. to obtain an acrylic resin sheet (Optical Film 1) having a lactone ring structure with a thickness of 40 μm.

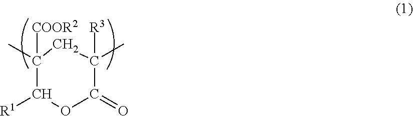

In Formula (1), R¹ is a hydrogen atom, and R² and R³ are a methyl group.

[Manufacture of Optical Films 2 to 4]

An unstretched acrylic resin sheet was manufactured in the same conditions as in Film 1 except for the thickness, and the unstretched sheet was stretched in a TD direction to manufacture Optical Films 2 to 4 described in the following Table 1. At this time, the raw fabric thickness and stretching ratio of the unstretched sheet were appropriately adjusted to obtain a film having characteristics in Table 1.

Meanwhile, a tensile elastic modulus in a TD direction may be increased by increasing the stretching ratio in the TD direction.

[Manufacture of Optical Film 5]

An imidized resin was obtained by a method described in [0173] to [0176] of Japanese Patent Application Laid-Open No. 2011-138119. The imidized resin is an acrylic resin, which has a glutarimide ring structure and does not have an aromatic vinyl structure, in a main chain thereof.

100 parts by mass of the imidized resin obtained and 0.10 parts by mass of the following triazine compound A were prepared into a pellet using a single-screw extruder. By using the pellet, the unstretched film was stretched in a longitudinal direction (MD direction) and in a transverse direction (TD direction), and the other conditions were used in the same manner as in Optical Film 1 to manufacture Optical Film 5. The thickness of Optical Film 5 obtained was 40 μm.

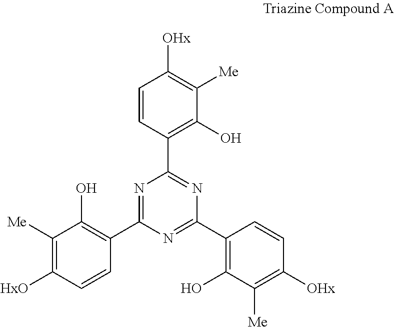

Me and Hx represent a methyl group and a hexyl group, respectively.

[Manufacture of Optical Film 6]

An unstretched acrylic resin sheet was manufactured in the same conditions as in Optical Film 5 except for the thickness, and the unstretched sheet was stretched in a TD direction while the raw fabric thickness and the stretching ratio were appropriately adjusted, to manufacture Optical Film 6 described in the following Table 1.

[Manufacture of Optical Film 7]

A PMMA (polymethyl methacrylate) resin (DELPET 80N manufactured by Asahi Kasei Chemicals Corporation) was dried by a vacuum dryer at 90° C. to set the water content ratio to 0.03% or less, and 1.0 part by mass of an ultraviolet absorbent (ADK STAB LA-31 manufactured by ADEKA Corporation) and 0.3 parts by mass of a stabilizer (IRGANOX 1010 (manufactured by BASF Corporation)) were mixed with 100 parts by mass of the PMMA (polymethyl methacrylate) resin at 230° C. by means of a twin-screw kneader to manufacture a PMMA resin pellet.

The PMMA resin pellet manufactured above was melt-extruded from a coat hanger type T-die using a twin-screw extruder to prepare an unstretched film. The unstretched film was stretched in a longitudinal direction and a transverse direction to manufacture Optical Film 7. The thickness of the film obtained was 40 μm.

[Manufacture of Optical Films 8 to 10]

An unstretched acrylic resin sheet was manufactured in the same conditions as in Optical Film 7 except for the thickness, and the unstretched sheet was stretched in a TD direction while the raw fabric thickness and the stretching ratio were appropriately adjusted, to manufacture Optical Films 8 to 10 described in the following Table 1. At this time, the raw fabric thickness and stretching ratio of the unstretched sheet were appropriately adjusted to obtain a film having characteristics in Table 1.

[Manufacture of Optical Films 11 and 12]

(Preparation of Application Composition HCL-1 for Forming Hardcoat Layer)

8 parts by mass of pentaerythritol triacrylate, 0.5 parts by mass of IRGACURE 127 (manufactured by BASF Corp.) and 4 parts by mass of a bifuntional acrylic compound represented by the following Formula C-3 were mixed to prepare an application product (HCL-1) for forming a hardcoat layer.

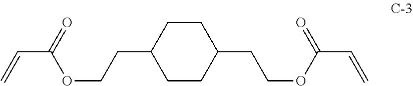 [SMILES: C=CC(=O)OCCC1CCC(CCOC(=O)C=C)CC1]

[Manufacture of Hardcoat Layer]

An application solution (HCL-1) for forming a hardcoat layer was applied on Optical Film 1 manufactured above by a die coat method, dried at 80° C. for 5 minutes, and then UV rays were irradiated at an irradiation dose of 300 mJ/cm² using an “air-cooled metal halide lamp” {manufactured by Eye Graphics Co., Ltd.} of 240 W/cm under nitrogen purge to cure the application layer, thereby forming a hardcoat layer having a dried film thickness of 5 μm.

In this manner, Optical Film 11 having a hardcoat layer was manufactured.

In the same manner, Optical Film 12 having a hardcoat layer was manufactured on Optical Film 3.

Here, a film thickness [μm], a tensile elastic modulus [GPa], a humidity dimensional change rate [%], Re and Rth [nm] were measured as follows.

[Measurement of Film Thickness]

A 5 cm by 5 cm sample was prepared and left to stand in an environment of 25° C. and a relative humidity of 60% for 48 hours, and then an average value obtained by measuring 6 points of in-plane film thickness with a micrometer was used as a film thickness.

[Tensile Elastic Modulus]

The elastic modulus of the optical film was measured in accordance with a method described in JIS K 7127.

The winding direction of the film roll refers to a longitudinal direction (MD direction) and a direction orthogonal to the longitudinal direction refers to a width direction (TD direction). The longitudinal direction or the width direction was set as a measurement direction, and a film sample was cut into a length of 15 cm and a width of 1 cm in the measurement direction. The sample was provided on STROGRAPH V 10-C manufactured by TOYO SEIKI Co., Ltd. such that the chuck distance in the longitudinal direction was 10 cm, a load was applied thereto such that the chuck distance was widened at a stretch rate of 10 mm/minute, and force at this time was measured. A tensile elastic modulus was calculated from the thickness of the film previously measured with a micrometer, the force and the elongation amount.

[Humidity Dimensional Change Rate of Optical Film]

The humidity dimensional change rate of the optical film was measured by the following method.

The winding direction of the film roll refers to a longitudinal direction (MD direction) and a direction orthogonal to the longitudinal direction refers to a width direction (TD direction). The width direction (TD direction) was set as a measurement direction, and a film sample was cut into a length of 12 cm and a width of 3 cm in the measurement direction. Along the measurement direction, pin holes were perforated on the sample at an interval of 10 cm, humidity was controlled at 25° C. and a relative humidity of 60% for 24 hours, and then the intervals (lengths) of pin holes were measured with a pin gauge. Subsequently, humidity was controlled at 25° C. and a relative humidity of 10% for 24 hours, and then the intervals of pin holes were measured with a pin gauge. Subsequently, the sample was humidity-controlled at 25° C. and a relative humidity of 80% for 24 hours, and then the intervals of pin holes were measured with a pin gauge. The humidity dimensional change rate in the TD direction was calculated by the following Equation using these measurement values.

Humidity dimensional change rate in the TD direction (%)=[{(a length at 25° C. and a relative humidity of 80%)−(a length at 25° C. and a relative humidity of 10%)}/(a length at 25° C. and a relative humidity of 60%)]×100 (Equation)

[Measurement of Re and Rth]

The Re and Rth of the optical film were measured by the following method.

After each film was humidity-controlled at 25° C. and a relative humidity of 60% for 24 hours, phase difference values at a wavelength of 590 nm were measured at 25° C. and a relative humidity of 60% in a direction perpendicular to the film surface and in a direction inclined by a 10° pitch of +50° to −50° from the normal line of the film surface by using the slow axis as the rotation axis by means of an automatic birefringence analyzer (KOBRA 21 ADH: manufactured by Oji Scientific Instruments Inc.), and then an in-plane retardation value (Re) and a retardation value (Rth) in a thickness-direction were calculated.

TABLE 1

| | | | | | Humidity |
|---|---|---|---|---|---|
| | | | | | Dimensional |
| | Tensile Elastic Modulus | | | Thick- | Change Rate |
| Optical | EMD (GPa)/ | EMD/ | Re (nm)/ | ness | in TD |
| Film | ETD (GPa) | ETD | Rth (nm) | (nm) | direction (%) |
| Film 1 | 3.3/3.1 | 1.08 | 1/−4 | 40 | 0.26 |
| Film 2 | 2.8/3.6 | 0.78 | 1/−5 | 40 | 0.18 |
| Film 3 | 2.7/3.7 | 0.73 | 1/−6 | 40 | 0.17 |
| Film 4 | 2.6/3.9 | 0.66 | 1/−7 | 40 | 0.15 |
| Film 5 | 3.4/3.2 | 1.08 | 1/−4 | 40 | 0.26 |
| Film 6 | 2.9/3.7 | 0.78 | 1/−6 | 40 | 0.17 |
| Film 7 | 3.0/2.8 | 1.08 | −1/−7 | 40 | 0.26 |
| Film 8 | 2.5/3.3 | 0.77 | −29/−20 | 40 | 0.16 |
| Film 9 | 3.0/2.8 | 1.08 | 0/−5 | 30 | 0.26 |
| Film 10 | 2.5/3.3 | 0.77 | −22/−15 | 30 | 0.16 |
| Film 11 | 3.4/3.2 | 1.08 | 1/−4 | 45 | 0.24 |
| Film 12 | 2.8/3.8 | 0.74 | 1/−6 | 45 | 0.15 |

<Acetyl Cellulose Film>

As an acetyl cellulose film, tack film TD60 (film thickness 60 μm) manufactured by Fujifilm Corporation was used.

<Polyester Film>

[Synthesis of Raw Material Polyester]

(Raw Material Polyester 1)

As described below, a polyester resin (Sb catalyst-based PET) was obtained, using a continuous polymerization apparatus, by using esterification method in which terephthalic acid and ethylene glycol were directly reacted with each other, and water was removed by filtration, and after esterification, polycondensation was carried out under reduced pressure.

(1) Esterification Reaction

High purity terephthalic acid in an amount of 4.7 tons and ethylene glycol in an amount of 1.8 tons were mixed in a first esterification reaction tank over 90 minutes to form slurry, and the slurry was continuously supplied at a flow rate of 3,800 kg/hour to the first esterification reaction tank. Further, an ethylene glycol solution of antimony trioixde was supplied continuously, and reaction was carried out at a temperature of 250° C. inside the reaction tank and an average retention time of about 4.3 hours with stirring. At this time, antimony trioxide was continuously added thereto such that the addition amount of Sb was 150 ppm in terms of the element converted value.

The resulting reaction product was transferred to a second esterification reaction tank, and reacted with stirring at a temperature of 250° C. inside the reaction tank and an average retention time of 1.2 hours. To the second esterification reaction tank, an ethylene glycol solution of magnesium acetate and an ethylene glycol solution of trimethyl phosphate were continuously supplied such that the addition amounts of Mg and P are 65 ppm and 35 ppm, respectively in terms of the element converted values.

(2) Polycondensation Reaction

The esterification reaction product obtained above was supplied continuously to a first polycondensation reaction tank, and polycondensation was carried out with stirring at a reaction temperature of 270° C., a pressure of 20 Torr (2.67×10⁻³ MPa) inside the reaction tank, and an average retention time of about 1.8 hours.

The reaction product was transferred to a second polycondensation reaction tank, and in this reaction tank, reaction (polycondensation) was carried out with stirring at a temperature of 276° C. inside the reaction tank, a pressure of 5 Torr (6.67×10⁻⁴ MPa) inside the reaction tank, and a retention time of about 1.2 hours.

Subsequently, the reaction product was also transferred to a third polycondensation reaction tank, and in this reaction tank, reaction (polycondensation) was carried out at a temperature of 278° C. inside the reaction tank, a pressure of 1.5 Torr (2.0×10⁻⁴ MPa) inside the reaction tank and a retention time of 1.5 hours, so that a reaction product (polyethylene terephthalate (PET)) was obtained.

Subsequently, the obtained reaction product was discharged into cold water in a strand form and immediately cut, so that polyester pellets <cross section: about 4 mm of long diameter and about 2 mm of short diameter, length: about 3 mm> were manufactured.

For the polymer obtained, IV=0.63 (hereinafter, referred to as PET1).

<Preparation of Polyester Film>
—Film Formation Process—

Raw material polyester (PET) was dried to have a water content ratio of 20 ppm or less, and then is fed into Hopper 1 of a single-screw kneading extruder 1 with a diameter of 50 mm Raw material Polyester 1 was melt at 300° C., and extruded from a die through a gear pump and a filter (a pore diameter of 20 μm) according to the following extrusion conditions.

The melt resin was extruded from the die under the melt resin extrusion conditions of a pressure change of 1% and a temperature distribution of 2% in the melt resin. Specifically, for the back pressure, pressure was applied by pressure 1% higher than an average pressure inside the barrel of the extruder, and for the piping temperature of the extruder, heating was performed at a temperature by 2% higher than an average temperature inside the barrel of the extruder.

The melt resin extruded from the die was extruded onto a cooling cast drum set to a temperature of 25° C., and was closely adhered to the cooling cast drum by using a static electricity applying method. An unstretched polyester film was obtained by peeling off the melt resin by means of a peeling roll disposed opposite to the cooling cast drum.

The intrinsic viscosity (IV) of the unstretched polyester film obtained was 0.62.

The unstretched polyester film was dissolved in a 1,1,2,2-tetrachloroethane/phenol (=⅔ [mass ratio]) mixed solvent, and the IV was obtained from a solvent viscosity at 25° C. in the mixed solvent.

—Transverse Stretching Process—

The unstretched polyester film was led to a tenter (transverse stretcher), and was transversely stretched while being grasped with clips at ends of the film by the following method under the following conditions.

(Preheating Part)

By setting the preheating temperature to 90° C., heating was carried out up to a stretchable temperature.

(Stretching Part)

The preheated and unstretched polyester film was transversely stretched in the width direction under the following conditions.

<Conditions>
Transverse stretching temperature: 90° C.
Transverse Stretching Magnification: 4.3 times

(Heat Fixation Part)

Subsequently, heat fixation treatment was performed while the film surface temperature of the polyester film was controlled to the following range.

<Conditions>
Heat fixation temperature: 180° C.
Heat fixation time: 15 seconds

(Heat Relaxation Part)

The polyester film after heat fixation was relaxed by heating the film to the following temperature.
Heat relaxation temperature: 170° C.
Heat relaxation ratio: TD direction (film width direction) 2%

(Cooling Part)

Subsequently, the polyester film after heat relaxation was cooled at a cooling temperature of 50° C.

(Collection of Film)

After cooling, both ends of the polyester film were trimmed by 20 cm. Thereafter, both ends of the polyester film were subjected to an extrusion processing (knurling) at a width of 10 mm, followed by winding at a tension of 18 kg/m.

In this manner, a polyester film having a thickness of 65 μm was prepared.

<Manufacture of Cycloolefin Polymer Film (COP Film)>

750 mmols (70.5 g) of bicyclo[2.2.1]hept-2-ene as a monomer, 475 millimole (63.6 g) of tricyclo[5.2.1.0^{2,6}]deca-8-ene having an endo content of 95%, 25 mmols (6.4 g) of 5-triethoxysilyl-bicyclo[2.2.1]hept-2-ene, 562 g of cyclohexane as a solvent, 141 g of methylene chloride, and 15.0 mmols of styrene as a molecular weight controlling agent were fed to a 2,000 mL reaction vessel under nitrogen. A hexane solution of nickel octanoate was reacted with hexafluoroantimonic acid at −10° C. in a molar ratio of 1:1 in advance, the by-produced precipitated Ni(SbF₆)₂ was removed, and a hexafluoroantimonic acid-modified product of nickel octanoate diluted with a toluene solution, 0.25 mmol of the hexafluoroantimonic acid modified product as an Ni atom, 2.50 mmols of triethylaluminum and 0.75 mmol of boron trifluoride ethyl etherate were prepared to carry out polymerization. The polymerization was carried out at 25° C. for 3 hours, and terminated with methanol. The conversion ratio of the monomers into a copolymer was 80%.

660 ml of water and 47.5 mmols of lactic acid were added to the copolymer solution, stirred, mixed and reacted with a catalytic component, and water was separated from the copolymer solution by standing. A copolymer solution from which a water phase containing the reaction product of the catalytic component had been removed was added to 3 liters of isopropyl alcohol to coagulate the copolymer, and unreacted monomers and the remaining catalyst residue were removed. The coagulated copolymer was dried to obtain a copolymer A.

It was found from the gas chromatography analysis of the unreacted monomers in the copolymer solution that the ratio of a structural unit derived from tricyclo[5.2.1.0^{2,6}]deca-8-ene in the copolymer A is 35% by mole. The ratio of a structural unit derived from 5-triethoxysilyl-bicyclo[2.2.1]hept-2-ene was 2.0% by mol.

The copolymer A had a number average molecular weight (Mn) of 142,000 in terms of polystyrene, a weight average molecular weight (Mw) of 284,000 and an Mw/Mn of 2.0. Furthermore, the copolymer A had a glass transition temperature of 390° C. The copolymer A was dissolved in cyclohexane at 25° C., but not in n-heptane.

10 g of the copolymer A was dissolved in a mixed solvent of 45 ml of cyclcohexane as a good solvent and 5 ml of n-heptane as a poor solvent, 0.6 parts by mass of pentaerythrityl-tetrakis[3-(3,5-di-t-butyl-4-hydroxyphenyl)propionate] and 0.6 parts by mass of tris(2,4-di-t-butylphenyl)phosphite as antioxidants based on 100 parts by mass of the copolymer A and 0.05 parts by mass of tributyl phosphite as a crosslinking agent based on 100 parts by mass of the copolymer A are added. This polymer solution was filtered with a membrane filter having a pore diameter of 10 μm to remove foreign matters, and then cast at 25° C., the temperature of the atmosphere was slowly increased up to 50° C. to evaporate the mixed solvent, and after the remaining solvent in the film is 2%, the film was exposed to steam at 150° C. for 3 hours to obtain the film as a crosslinked body. Thereafter, an unstretched COP film was manufactured by vacuum-drying the film at 100° C. for 30 minutes to remove moisture on the surface thereof.

The unstretched COP film was heated to 130° C. in a tenter, was stretched by 1.15 times in a longitudinal direction of an in-plane direction of the film and by 1.4 times in a transverse direction, at a stretch rate of 300%/minutes, and a COP film was obtained by cooling the unstretched COP film while maintaining the state under an atmosphere of 90° C. for about 1 minute, further cooling the unstretched COP film at room temperature, and taking out the unstretched COP film from the tenter. The thickness was 50 μm.

[Manufacture of Polarizer]

200 kg of water at 18° C. was put into a 500 L tank, 42 kg of a polyvinyl alcohol-based resin having a weight average molecular weight of 165,000 and a saponification degree of 99.8% by mol was added thereto with stirring, and the resulting mixture was stirred for 15 minutes. The slurry obtained was dehydrated to obtain a polyvinyl alcohol-based resin wet cake having a water content ratio of 40%.

70 kg (resin content 42 kg) of the polyvinyl alcohol-based resin wet cake was put into a dissolving tank, 4.2 kg of glycerin as a plasticizer and 10 kg of water were added thereto, and steam was blown into the bottom of the tank. At the time when the resin temperature inside the tank reached 50° C., the resulting mixture was stirred (number of rotations: 5 rpm), and at the time when the resin temperature inside the tank reached 100° C., the inside of the system was pressurized and the temperature was increased to 150° C., and then the steam blowing was stopped (the blowing amount of steam is 75 kg in total). The mixture was uniformly dissolved by stirring the mixture (number of rotations: 20 rpm) for 30 minutes, and then a polyvinyl alcohol-based resin aqueous solution was obtained at a polyvinyl alcohol-based resin concentration to water of 23% by adjusting the concentration.

Subsequently, the polyvinyl alcohol-based resin aqueous solution (liquid temperature 147° C.) was fed into a twin-screw extruder from a feed gear pump, degassed, and then discharged by a discharge gear pump. A film was formed by casting the discharged polyvinyl alcohol-based resin aqueous solution onto a cast drum from a T-shaped slit die (straight manifold die). Conditions of the casting film formation were as follows.

Cast drum diameter (R1): 3200 mm

Cast drum width: 4.3 m

Cast drum rotation speed: 8 m/min

Cast drum surface temperature: 90° C.

Resin temperature of T-shaped slit die exit: 95° C.

The front and rear surfaces of the film obtained were dried while being allowed to

alternately pass through a plurality of drying rolls under the following conditions.

Drying roll diameter (R2): 320 mm

Drying roll width: 4.3 m

Drying roll line number (n): 10 lines

Drying roll rotation speed: 8 m/min

Drying roll surface temperature: 50° C.

The polyvinyl alcohol film manufactured above (length 4000 m, width 4 m, and thickness 60 μm) was immersed in warm water at 40° C. for 2 minutes and subjected to swelling treatment, and then stretched by 1.30 times. The film obtained was subjected to dyeing treatment with iodide and iodine by being immersed in an aqueous solution containing 28.6 g/L of boric acid (manufactured by Societa Chimica Larderello S.p.A), 0.25 g/L of iodine (manufactured by JUNSEI CHEMICAL CO., Ltd.) and 1.0 g/L of potassium iodide (manufactured by JUNSEI CHEMICAL CO., Ltd.) at 30° C. for 2 minutes. The film obtained from the dyeing treatment was subjected to treatment in an aqueous solution containing 30.0 g/L of boric acid at 50° C. for 5 minutes while being uniaxially stretched by 5.0 times. The film obtained was subjected to drying treatment at 70° C. for 9 minutes.

[Adhesive Bond for Polarizing Plate Used in Adhesion Method A]

An adhesive bond for a polarizing plate was prepared by blending 100 parts by mass of 2-hydroxyethyl acrylate, 10 parts by mass of tolylene diisocyanate and 3 parts by mass of a photopolymerization initiator (IRGACURE 907, manufactured by BASF Co., Ltd.).

(Manufacture of Polarizing Plate Using Adhesion Method A)

The long-sized optical films 1 to 12, the COP film and the polyester film were manufactured by the aforementioned method, and the surfaces thereof were subjected to corona treatment. Subsequently, the adhesive bond for a polarizing plate was coated on each film using a microgravure coater (gravure roll: #300, rotation speed 140%/line speed) such that the thickness was 5 μm, thereby manufacturing optical films containing an adhesive bond. Subsequently, the optical film containing the adhesive bond was adhered to both surfaces of the polarizer by roll-to-roll by means of a roll machine. At this time, a polarizing plate sample was prepared by selecting a combination of optical films described in Tables 2, 4 and 5 as protective films on the air side (viewing side) and protective films on the cell side. A polarizing plate having transparent protective films on both sides of the polarizer was obtained by irradiating UV rays on optical film sides (both sides) adhered. The line speed and the light quantity of the ultraviolet rays were set to 20 m/min and 300 mJ/cm², respectively.

Accordingly, a polarizing plate sample was obtained, in which a film length was 500 m, the absorption axis is in a longitudinal direction, a slow axis was in a direction orthogonal to the longitudinal direction, and both surfaces were protected by the optical film.

Polarizing plate samples 1 to 15 and 25 to 36 were manufactured by the present adhesion method.

(Manufacture of Polarizing Plate Using Adhesion Method B)

The surfaces of the long-sized optical films 1 to 3 and 5 to 10 manufactured by the aforementioned method, the surfaces thereof were subjected to corona treatment. Subsequently, the surface of the long-sized tack film TD60 was subjected to saponification treatment. The optical film subjected to corona treatment and the tack film subjected to saponification treatment were adhered to both surfaces of the polarizer by roll-to-roll by means of a roll machine using a polyvinyl alcohol-based adhesive bond, such that the polarizer was sandwiched between the optical film and the tack film, and dried at 70° C. for 10 minutes or more. At this time, a polarizing plate sample was prepared by selecting a combination of optical films described in Table 3 as protective films on the air side (viewing side) and protective films on the cell side. Accordingly, a polarizing plate sample was obtained, in which a film length was 500 m, the absorption axis was in a longitudinal direction, a slow axis was in a direction orthogonal to the longitudinal direction, and both surfaces were protected by the optical film.

Polarizing plate samples 16 to 24 were manufactured by the present adhesion method.

(Adhesion of Laminate Film)

In each polarizing plate sample manufactured, a laminate film (film thickness 38 μm) including polyethylene terephthalate, which contained an adhesive, as a main component, was adhered to the protective film side on the air side by roll-to-roll by means of a roll machine.

(Formation of Adhesive Layer)

(Preparation of Adhesive)

A solution was prepared by adding 100 parts by mass of isooctyl acrylate, 0.085 parts by mass of acrylic acid 6-hydroxyhexyl, 0.4 parts by mass of 2,2′-azobisisobutyronitrile, and ethyl acetate to a reaction vessel equipped with a cooling tube, a nitrogen introducing tube, a thermometer and a stirrer. Subsequently, the solution was stirred while nitrogen gas was blown thereinto, and allowed to react at 60° C. for 4 hours to obtain a solution containing an arylic polymer PA having a weight average molecular weight of 1,750,000. Furthermore, an acrylic polymer solution adjusted to have a solid content concentration of 30% by mass was obtained by adding ethyl acetate to the solution containing the acrylic polymer PA.

An adhesive solution was prepared by blending 2.5 parts by mass of a crosslinking agent (manufactured by Nippon Polyurethane Industry Co., Ltd., trade name “Colonate L”) including a compound including an isocyanate group as a main component and 0.02 parts by mass of γ-glycidoxypropyltrimethoxy silane (Shin-Etsu Chemical Co., Ltd., trade name “KBM-403”) as a silane coupling agent in this order, based on 100 parts by mass of a solid content of the acrylic polymer solution.

(Formation of Adhesive Layer)

The adhesive solution was uniformly coated on the protective film side on the cell side of the polarizing plate sample manufactured by means of a slot die coater, and the resulting sample was allowed to pass through an air circulation-type constant temperature bath at 155° C. for 5 minutes, so that an adhesive layer having a thickness of 15 μm was formed on the surface of the polarizing plate. On the adhesive layer formed, a separator film (film thickness 38 μm) including polyethylene terephthalate as a main component was adhered by roll-to-roll by means of a roll machine.

(Punching of Polarizing Plate)

The polarizing plate manufactured was punched into the following size in order to be adhered to a 42-inch liquid crystal display device.
Front Side

MD direction 929.8 mm

TD direction 523.0 mm
Rear Side

MD direction 523.0 mm

TD direction 929.8 mm

The polarizing plate punched into the size was introduced into an aluminum moisture barrier bag (manufactured by ADY Ltd.), and hermetically sealed with a heat sealer set to a temperature of 180° C. The aluminum moisture barrier bag which enclosed the polarizing plate was stored in an environment of a temperature of 25° C.

[Humidity Dimensional Change Rate of Polarizing Plate Sample]

In order to evaluate expansion characteristics of the polarizing plate sample manufactured, the humidity dimensional change rate in the TD direction was measured.

Here, the humidity dimensional change rate of the polarizing plate sample was measured by the following method.

The absorption axis direction of the polarizing plate refers to a longitudinal direction (MD direction) and a direction orthogonal to the longitudinal direction refers to a width direction (TD direction). The width direction (TD direction) was set as a measurement direction, and a film sample was cut into a length of 12 cm and a width of 3 cm in the measurement direction. At this time, the film sample was cut with a separator film and a laminate film attached, and measured. Along the measurement direction, pin holes were perforated in the sample at an interval of 10 cm, humidity was controlled at 25° C. and a relative humidity of 60% for 72 hours, and then the intervals (lengths) of pin holes were measured with a pin gauge. Subsequently, humidity was controlled at 25° C. and a relative humidity of 10% for 72 hours, and then the intervals of pin holes were measured with a pin gauge. Subsequently, the sample was humidity-controlled at 25° C. and a relative humidity of 80% for 72 hours, and then the intervals of pin holes were measured with a pin gauge. The humidity dimensional change rate in the TD direction was calculated by the following Equation using these measurement values.

Humidity dimensional change rate in the TD direction (%)=[{(a length at 25° C. and a relative humidity of 80%)−(a length at 25° C. and a relative humidity of 10%)}/(a length at 25° C. and a relative humidity of 60%)]×100 (Equation)

[Manufacture of Liquid Crystal Display Device]

A liquid crystal cell for an experiment was prepared by peeling off each polarizing plate on the front side and the rear side from a commercially available IPS-mode liquid crystal television set (42LA6900 manufactured by LG Electronics Corp.). Subsequently, the polarizing plate punched into a 42-inch size was taken out from the aluminum moisture bather bag, and allowed to stand in an environment of 25° C. and a relative humidity of 60% for 72 hours. Therefore, the separator film was peeled-off from the polarizing plate, and each of the polarizing plate was adhered on the front side and the rear side of the liquid crystal cell prepared. At this time, the crossed Nichol was disposed such that the absorption axis of the polarizing plate on the front side was in the longitudinal direction (crosswise direction) and the transmission axis of the polarizing plate on the rear side was in the longitudinal direction (crosswise direction). The thickness of glass used in the liquid crystal cell was 0.5 mm Further, at this time, for the environment, the temperature was 25° C. and the relative humidity was 60%. The films on the air side (side far from the liquid crystal cell (viewing side and backlight side)) and on the cell side (side close to the liquid crystal cell) were manufactured with the configuration shown in Tables 2 to 5.

[Evaluation of Expansion on Liquid Crystal Cell]

Immediately after the polarizing plate was adhered to the liquid crystal cell, a carpenter's square ruler was placed on the polarizing plate on the front side, and the length in the TD direction of the polarizing plate on the liquid crystal cell was measured by capturing marks on the carpenter's square ruler and the corners of the polarizing plate by means of a digital camera. At this time, for the environment, the temperature was 25° C. and the relative humidity was 60%. An elongation amount due to expansion was calculated by subtracting 523.0 mm, which was the length of the 42 inch size polarizing plate in the TD direction, from the length obtained above. When the expansion on the liquid crystal cell is 0.80 mm or more, practical problems occur. Lower expansion is preferred, and a value less than 0.80 mm is preferred, and a value less than 0.70 mm is more preferred.

[Evaluation of Protrusion Amount from Glass End]

Immediately after the polarizing plate was adhered to the liquid crystal cell, a carpenter's square ruler was placed on the polarizing plate on the front side in the TD direction, such that the mark “0” started from the glass end of the liquid crystal cell, and marked on the carpenter's square ruler and the corners of the polarizing plate are captured by means of a digital camera. The mark on the ruler coinciding with the corner of the polarizing plate was read, and the value of the mark referred to a protrusion amount from the glass end. At this time, the upper and lower parts in the TD direction were measured, and the part having a larger protrusion amount referred to a part having a protrusion amount from the glass end. A sign in the case of protruding from the glass end was set as positive, and a sign in the case of receding than the glass end was set to negative. A smaller value in protrusion amount from the glass end is preferred, and the value is preferably less than 0.08 mm and more preferably 0.03 mm, and it is most preferred that the value is negative.

These evaluation results are shown in Tables 2 to 5. From the results of Tables 2 to 5, it is obvious that the optical film of the present disclosure is effective for reducing expansion of the polarizing plate. It is thought that this is because a high elastic modulus and a high anisotropy in the TD direction of the optical film suppress expansion due to moisture absorption of the transmission axis of the polarizer.

TABLE 2

| | | | | Dimensional | Expansion | Protrusion |
|---|---|---|---|---|---|---|
| | | Protective | Protective | Change rate in TD | on Liquid | Amount |
| | | Film on Air | Film on Cell | Direction of | Crystal | from Glass |
| | | Side | Side | Polarizing Plate (%) | Cell (mm) | End (mm) |
| C. Ex. 1 | Polarizing Plate Sample 1 | Optical Film 1 | Optical Film 1 | 0.92 | 0.85 | 0.11 |
| Ex. 1 | Polarizing Plate Sample 2 | Optical Film 2 | Optical Film 1 | 0.87 | 0.80 | 0.08 |
| Ex. 2 | Polarizing Plate Sample 3 | Optical Film 3 | Optical Film 1 | 0.86 | 0.79 | 0.08 |
| Ex. 3 | Polarizing Plate Sample 4 | Optical Film 4 | Optical Film 1 | 0.85 | 0.78 | 0.07 |
| Ex. 4 | Polarizing Plate Sample 5 | Optical Film 2 | Optical Film 2 | 0.82 | 0.75 | 0.06 |
| Ex. 5 | Polarizing Plate Sample 6 | Optical Film 3 | Optical Film 3 | 0.80 | 0.73 | 0.05 |
| Ex. 6 | Polarizing Plate Sample 7 | Optical Film 4 | Optical Film 4 | 0.78 | 0.71 | 0.04 |
| C. Ex. 2 | Polarizing Plate Sample 8 | Optical Film 5 | Optical Film 5 | 0.91 | 0.83 | 0.10 |
| Ex. 7 | Polarizing Plate Sample 9 | Optical Film 6 | Optical Film 6 | 0.79 | 0.72 | 0.04 |
| C. Ex. 3 | Polarizing Plate Sample 10 | Optical Film 7 | Optical Film 7 | 0.96 | 0.89 | 0.13 |
| Ex. 8 | Polarizing Plate Sample 11 | Optical Film 8 | Optical Film 8 | 0.83 | 0.76 | 0.06 |
| C. Ex. 4 | Polarizing Plate Sample 12 | Optical Film 9 | Optical Film 9 | 1.09 | 1.00 | 0.18 |
| Ex. 9 | Polarizing Plate Sample 13 | Optical Film 10 | Optical Film 10 | 0.96 | 0.88 | 0.12 |
| C. Ex. 5 | Polarizing Plate Sample 14 | Optical Film 11 | Optical Film 1 | 0.88 | 0.81 | 0.09 |
| Ex. 10 | Polarizing Plate Sample 15 | Optical Film 12 | Optical Film 1 | 0.81 | 0.74 | 0.05 |

From a polarizing plate in which acrylic resin films are used on both surfaces on the air side and on the cell side, it is possible to obtain a liquid crystal display device, which is low in generation of unevenness and beautiful in display, due to low photoelastic characteristics of the polarizing plate. In addition, since dynamic characteristics (elastic modulus and thermal expansion coefficient) of both surfaces are close to each other due to use of the same kind of resin on both surfaces, there is an advantage in that curling of the polarizing plate is low. Furthermore, it is possible to suppress the expansion of the polarizing plate which is easily expanded in the TD direction, by using the optical film of the present invention having an elastic modulus ratio (EMD/ETD) less than 0.8 on at least one side of the air side and the cell side.

TABLE 3

| | | | | Dimensional | Expansion | Protrusion |
|---|---|---|---|---|---|---|
| | | Protective | Protective | Change rate in TD | on Liquid | Amount |
| | | Film on Air | Film on Cell | Direction of | Crystal | from Glass |
| | | Side | Side | Polarizing Plate (%) | Cell (mm) | End (mm) |
| C. Ex. 6 | Polarizing Plate Sample 16 | TD60 | Optical Film 1 | 0.87 | 0.8 | 0.08 |
| Ex. 11 | Polarizing Plate Sample 17 | TD60 | Optical Film 2 | 0.83 | 0.76 | 0.06 |
| Ex. 12 | Polarizing Plate Sample 18 | TD60 | Optical Film 3 | 0.82 | 0.75 | 0.06 |
| C. Ex. 7 | Polarizing Plate Sample 19 | TD60 | Optical Film 5 | 0.87 | 0.79 | 0.08 |
| Ex. 13 | Polarizing Plate Sample 20 | TD60 | Optical Film 6 | 0.82 | 0.75 | 0.06 |
| C. Ex. 8 | Polarizing Plate Sample 21 | TD60 | Optical Film 7 | 0.89 | 0.81 | 0.09 |
| Ex. 14 | Polarizing Plate Sample 22 | TD60 | Optical Film 8 | 0.83 | 0.76 | 0.06 |
| C. Ex. 9 | Polarizing Plate Sample 23 | TD60 | Optical Film 9 | 0.92 | 0.85 | 0.11 |
| Ex. 15 | Polarizing Plate Sample 24 | TD60 | Optical Film 10 | 0.88 | 0.81 | 0.09 |

It is found that from a polarizing plate in which an acetyl cellulose-based film and an acrylic resin film are used on the air side and on the cell side, respectively, it is possible to obtain a liquid crystal display device, which is low in generation of unevenness and beautiful in display, due to low photoelastic characteristics of the polarizing plate. Further, by using an acetyl cellulose-based film having high hardness on the air side, it is difficult for scratch to be generated even though friction occurs, for example, between the air side surface of the polarizing plate on the backlight side and the backlight sheet. In addition, it is difficult for scratch to be generated even when a finger is touched on the air side surface of the polarizing plate on the viewing side or the air side surface is wiped with cloth or paper. Furthermore, by using an acetyl cellulose-based film having high water vapor permeability on one side of the protective film, a polarizing plate may be manufactured by a polarizing plate adhesion method using a polyvinyl alcohol-based adhesion, as well as a polarizing plate adhesion method using an UV adhesive bond.

It is possible to suppress the expansion of the polarizing plate which is easily expanded in the TD direction, by using the optical film of the present invention having an elastic modulus ratio (EMD/ETD) less than 0.8 as an acrylic resin film on the cell side.

TABLE 4

| | | | | Dimensional | Expansion | Protrusion |
|---|---|---|---|---|---|---|
| | | Protective | Protective | Change rate in TD | on Liquid | Amount |
| | | Film on Air | Film on Cell | Direction of | Crystal | from Glass |
| | | Side | Side | Polarizing Plate (%) | Cell (mm) | End (mm) |
| C. Ex. 10 | Polarizing Plate Sample 25 | COP Film | Optical Film 1 | 0.88 | 0.81 | 0.09 |
| Ex. 16 | Polarizing Plate Sample 26 | COP Film | Optical Film 3 | 0.82 | 0.75 | 0.06 |
| C. Ex. 11 | Polarizing Plate Sample 27 | COP Film | Optical Film 7 | 0.91 | 0.83 | 0.10 |
| Ex. 17 | Polarizing Plate Sample 28 | COP Film | Optical Film 8 | 0.84 | 0.77 | 0.07 |
| C. Ex. 12 | Polarizing Plate Sample 29 | Polyester Film | Optical Film 1 | 0.71 | 0.66 | 0.01 |
| Ex. 18 | Polarizing Plate Sample 30 | Polyester Film | Optical Film 3 | 0.67 | 0.62 | −0.01 |
| C. Ex. 13 | Polarizing Plate Sample 31 | Polyester Film | Optical Film 7 | 0.73 | 0.67 | 0.02 |
| Ex. 19 | Polarizing Plate Sample 32 | Polyester Film | Optical Film 8 | 0.68 | 0.63 | −0.01 |

From a polarizing plate in which a polyester (PET) or a COP film and an acrylic resin film are used on the air side and on the cell side, respectively, it is possible to obtain a liquid crystal display device, which is low in generation of unevenness and beautiful in display, due to low photoelastic characteristics of the polarizing plate. Furthermore, water may be prevented from entering and exiting the polarizer by using a polyester film or a COP film having low water vapor permeability on the air side, so that unevenness caused by deterioration of the polarizer may be suppressed from occurring. Further, it is possible to suppress the expansion of the polarizing plate, which is easily expanded in the TD direction, by using the optical film of the present invention having an elastic modulus ratio (EMD/ETD) less than 0.8 as an acrylic resin film on the cell side.

TABLE 5

| | | | | Dimensional | Expansion | Protrusion |
|---|---|---|---|---|---|---|
| | | Protective | Protective | Change rate in TD | on Liquid | Amount |
| | | Film on Air | Film on Cell | Direction of | Crystal | from Glass |
| | | Side | Side | Polarizing Plate (%) | Cell (mm) | End (mm) |
| C. Ex. 14 | Polarizing Plate Sample 33 | Optical Film 1 | COP Film | 0.88 | 0.81 | 0.09 |
| Ex. 20 | Polarizing Plate Sample 34 | Optical Film 3 | COP Film | 0.82 | 0.75 | 0.06 |
| C. Ex. 15 | Polarizing Plate Sample 35 | Optical Film 7 | COP Film | 0.91 | 0.83 | 0.10 |
| Ex. 21 | Polarizing Plate Sample 36 | Optical Film 8 | COP Film | 0.84 | 0.77 | 0.07 |

From a polarizing plate in which an acrylic resin film and a COP film are used on the air side and on the cell side, respectively, it is possible to obtain a liquid crystal display device, which is low in generation of unevenness and beautiful in display, due to low water content ratio characteristics of the COP film. In addition, it is possible to obtain phase difference characteristics suitable for a VA liquid crystal display device by stretching. Further, from an unstretched COP film, it is possible to obtain low retardation characteristics that are optical characteristics suitable for an IPS liquid crystal display device. Since it is possible to reduce water entering and exiting the polarizer by using the acrylic resin film on the air side, unevenness caused by deterioration of the polarizer may be suppressed from being generated. In addition, even when water enters the polarizer, the acrylic resin-based film has a characteristic of slightly permeating water, and thus may suppress water from being resident for a long period of time, and may suppress the polarization degree due to deterioration of the polarizer from being decreased. Furthermore, it is possible to suppress the expansion of the polarizing plate, which is easily expanded in the TD direction, by using the optical film of the present invention having an elastic modulus ratio (EMD/ETD) less than 0.8 as an acrylic resin film on the air side.

[Manufacture of Stereoscopic Display Device]

[Manufacture of Phase Difference Film]

Referring to “Site 2” and “Site 5” of Example 1 of Japanese Patent Application Laid-Open No. 2009-223001, a pattern phase difference layer A was manufactured on a glass substrate, in which the pattern phase difference layer A was patterned such that with Re=137.5 nm, a site (first region) and a site (second region) were periodically repeated, in which the slow axis direction was at 45 degrees and 135 degrees, respectively, with respect to the long side direction of the pattern. Phase difference films 1 to 3 having the pattern phase difference layer A were prepared by transferring the pattern phase difference layer A to Optical Films 1 to 3 (support) manufactured above. At this time, the pattern phase difference layer A was transferred to Optical Films 1 to 3 such that the longitudinal direction of the pattern phase difference layer A and the MD direction of Optical Films 1 to 3 were parallel to each other, and the repeating periodic direction of the phase difference and the MD direction of Optical Films 1 to 3 were orthogonal to each other.

Phase Difference Films 1 to 3 and Optical Films 1 to 3 manufactured above were adhered to both surfaces of the polarizer obtained above using an acrylic adhesive bond after the adhesion surface with the polarizer is subjected to corona treatment.

(Manufacture of 3D Monitor)

A front polarizing plate of HPL02065 (monitor manufactured by Hewlett Packard Inc.) was detached, and instead, a polarizing plate using a film in Examples and Comparative Examples as a protective film was adhered thereto. At this time, films on the outer side (viewing side) and on the inner side (liquid crystal cell side) were manufactured with configurations shown in Table 6.

(Evaluation of Dependence of Crosstalk on Environmental Humidity)

The 3D monitor manufactured above was allowed to stand in an environment of a temperature of 25° C. and a humidity of 60% for 48 hours, and then a pixel for the right eye and a pixel for the left eye were allowed to display a white pattern and a black pattern, respectively, a spectroradiometer (SR-3, manufactured by TOPCON CORPORATION) was placed at the position of the eyes, and light was allowed to pass through the circularly polarizing spectacles for the right eye/the left eye, respectively, so that brightness is measured.

Brightness when light is allowed to pass through circularly polarizing spectacles for the right eye refers to Y_PR and brightness when light is allowed to pass through circularly polarizing spectacles for the left eye refers to Y_RL.

Since the 3D sense is lost when an image for the right eye enters the left eye and an image for the left eye enters the right eye, the degree of crosstalk was defined as CRO=(Y_RR−Y_RL)/(Y_RR+Y_RL) and evaluated.

The 3D monitor manufactured above was allowed to stand in an environment of a temperature of 25° C. and a humidity of 10% for 48 hours, and the degree of crosstalk was evaluated likewise.

The CRO in an environment of a temperature of 25° C. and a humidity of 60% refers to CRO_{—}60% and the CRO in an environment of a temperature of 25° C. and a humidity of 10% referred to CRO_{—}10%, and evaluation was made based on the value of 100*CRO_{—}10%/CRO_{—}60% in accordance with the following criteria.

A: 95% or more

B: 92.5% or more and less than 95%

C: 90% or more and less than 92.5%

D: less than 90%

“A” is most preferred, “B” is next preferred, and “C” is next less preferred.

The results are shown in the following Table 6. From the results of Table 6, it becomes obvious that the optical film of the present invention is effective for reducing the crosstalk when the 3D display is continuously lit. It is thought that this is because a change in size of a support over time has been suppressed.

TABLE 6

| | | | Support Film | | |
|---|---|---|---|---|---|
| | | Phase | of Phase | | |
| | | Difference | Difference | | |
| | | Film on | Film on | Film on | Crosstalk |
| | | Outer Side | Outer Side | Inner Side | Evaluation |
| C. | Polarizing | Phase | Optical | Optical | C |
| Ex. 16 | Plate | Difference | Film 1 | Film 1 | |
| | Sample 37 | Film 1 | | | |
| Ex. 22 | Polarizing | Phase | Optical | Optical | B |
| | Plate | Difference | Film 2 | Film 1 | |
| | Sample 38 | Film 2 | | | |
| Ex. 23 | Polarizing | Phase | Optical | Optical | B |
| | Plate | Difference | Film 3 | Film 1 | |
| | Sample 39 | Film 3 | | | |
| Ex. 24 | Polarizing | Phase | Optical | Optical | B |
| | Plate | Difference | Film 2 | Film 2 | |
| | Sample40 | Film 2 | | | |
| Ex. 25 | Polarizing | Phase | Optical | Optical | A |
| | Plate | Difference | Film 3 | Film 3 | |
| | Sample 41 | Film 3 | | | |

While the present invention has been shown and described with reference to certain exemplary embodiments thereof, it will be understood by those skilled in the art that various changes modifications may be made therein without departing from the spirit and scope of the present invention as defined by the appended claims.

What is claimed is:

1. A VA mode liquid crystal display device comprising:
a backlight;
a first polarizing plate;
a VA mode liquid crystal cell; and
a second polarizing plate, in this order,
wherein the first polarizing plate includes a first polarizer and a first optical film, and
the second polarizing plate includes a second polarizer and a second optical film,
the optical film contains an acrylic resin, and
a tensile elastic modulus of the optical film in a machine direction, which are abbreviated as EMD, and a tensile elastic modulus in a direction perpendicular to the machine direction, which is abbreviated as ETD, satisfy the relationship of Equation (1):
EMD/ETD<0.8. Equation (1)

2. The VA mode liquid crystal display device according to claim 1,
wherein the EMD is 1.2×10⁹ to 4.0×10⁹ N/m² and the ETD is 1.5×10⁹ to 5.0×10⁹ N/m².

3. The VA mode liquid crystal display device according to claim 1,
wherein an in-plane retardation value Re (nm) represented by Equation (i) and a retardation value in a thickness-direction Rth (nm) represented by Equation (ii), of the optical film, satisfy Equation (iii) and Equation (iv):
Re=(nx−ny)×d; (i)
Rth=((nx+ny)/2−nz)×d; (ii)
0≦Re≦20; and (iii)

|Rth|≦25, (iv)
wherein nx is a refractive index in an in-plane slow axis direction of the optical film,
ny is a refractive index in an in-plane fast axis direction of the optical film,
nz is a refractive index in a thickness direction of the optical film, and
d is a thickness, of which unit is nm, of the optical film.

4. The VA mode liquid crystal display device according to claim 1,
wherein at least one layer of a pattern phase difference layer, a λ/4 layer, a hardcoat layer, an antiglare layer, an antireflection layer, an antistatic layer, an optically anisotropic layer or an adhesive layer is provided on a surface of the optical film.

5. The VA mode liquid crystal display device according to claim 1,
wherein the first polarizing plate includes the first optical film at a backlight side with respect to the first polarizer, and
the second polarizing plate includes the second optical film at a viewing side with respect to the second polarizer.

6. The VA mode liquid crystal display device according to claim 5,
wherein the first polarizing plate includes a cycloolefin polymer film at the viewing side with respect to the first polarizer, and
the second polarizing plate includes a cycloolefin polymer film at the backlight side with respect to the second polarizer.

7. The VA mode liquid crystal display device according to claim 1,
wherein the optical film is adhered to the polarizer with a UV curing adhesive.
